(19) United States
(12) Patent Application Publication
(10) Pub. No.: US 2003/0220844 A1
(43) Pub. Date: Nov. 27, 2003

(54) Method and system for purchasing genetic data

(76) Inventors: Georgios E. Marnellos, San Diego, CA (US); Bryan C. Coon, San Diego, CA (US); Michael Steven Cox, San Diego, CA (US)

Correspondence Address: Richard C. Kim, Morrison & Foerster LLP, Suite 500, 3811 Valley Centre Drive, San Diego, CA, 92130-2332, US

(21) Appl. No.: 10/215,554

(22) Filed: Aug. 8, 2002

Related U.S. Application Data
(60) Provisional application No. 60/383,217, filed on May 24, 2002.

(51) Int. Cl. G06F 17/60

(52) U.S. Cl. 705/26

(57) ABSTRACT

A computer-based method and system for providing genetic data is provided. In a preferred embodiment, the method and system perform the steps of: receiving search criteria from a user; searching a database for genetic data meeting the search criteria; displaying at least a portion of the genetic data in a first genetic data format, wherein the format includes a plurality of data entries meeting the search criteria; receiving a purchase request for additional information associated with at least one of the entries; retrieving the additional information from the database; storing the additional information in a memory location associated with the user such that the additional information may be subsequently accessed and viewed by the user; and automatically debiting a credit account associated with the user by a predetermined amount.

### CROSS-REFERENCE TO RELATED APPLICATIONS

This application asserts priority under 35 U.S.C. § 119 from U.S. provisional application Ser. No. 60/383,217 filed May 24, 2002, which is incorporated herein by reference in its entirety.

### BACKGROUND OF THE INVENTION

1. Field of the Invention

The present invention relates generally to the field of genetic research and, more specifically, to a computer-based method and system that allows researchers and research companies to search for and only pay for desired data (e.g., a specific SNP assay) contained in a genetic database.

2. Description of the Related Art

As a result of the tremendous advances made in DNA sequencing technology, the cumulative rate of growth of DNA databases has increased exponentially over the last decade from approximately 1.5 million nucleotides per year in 1989 to over 1.6 billion nucleotides per year in 1999. Since 1999, entire genomes have been sequenced, including those of drosophila, mouse, and human. For example, GenBank, a public repository of genomic information, currently has nearly 19 Giga Bases (GB) of sequence data, having grown from a mere 680 KB in 1982 (Benson et al., Nucleic Acids Research, 28(1):15-18 (2000) (See also www.ncbi.nlm.nih.gov/Genbank/genbankstats.html.)). At this rate, the amount of data is doubling nearly every 16.5 months. In 2001 alone, 3.5 million sequences totaling 3 GB of new sequence data were entered into GenBank. Both public and private sequencing facilities consist of warehouse-sized factories generating data around the clock, limited only by the availability of reagents and the speed of the sequencing machines.

As the amount of known genetic sequence information increases, researchers will have available to them new and vast amounts of information to study and experiment with. Such genetic sequence information has and will continue to enable significant advances in science and health care, not only in the pharmaceutical industry but also in other scientific endeavors such as understanding the nature and causes of diseases, genetic defects, and physical and behavioral traits, for example. Thus, it is imperative for researchers to be able to access and utilize this growing body of genetic information to aid in their research.

Computer-based methods and systems for searching and accessing information from databases are well-known in the art. A conventional computer system 10 that may be used to perform these functions is generally illustrated in FIG. 1. The system 10 includes a computer network, e.g., Internet 12, that allows multiple client computers 14a-n to communicate with a vendor company server computer 16 in accordance with TCP/IP communications protocols. The server 16 is coupled to a database 18 and controls access to the database 18 by client computers 14a-n (collectively and individually referred to as “client computer 14” below).

The Internet 12 is a global network of interconnected computers and computer networks. The interconnected computers and networks exchange information using various services, such as electronic email, Gopher and the world wide web (“www”). The www service allows the server computer 16 to send graphical “web pages” of information to client computers 14. Each resource (e.g., a computer or web page) connected to the Internet 12 is uniquely identifiable by a Uniform Resource Locator (“URL”). To view a specific web page, the client computer 14 specifies the URL for that web page in a request, e.g., a hypertext transfer protocol (“http”) request, which is forwarded to the server 16 that supports the web page. The server 16 responds to the request by sending the requested web page (e.g., a home page of a web site) to the client computer 14.

The client computer 14 may be connected to the Internet 12 by various means known in the art, such as dial-up modem connection to an Internet Service Provider (ISP) or a direct connection to a network that is connected to the Internet 12. Typically, the client computer 14 is a personal computer in a home or a business environment which accesses the Internet 12 through a commercially available browser software package (e.g., Microsoft's Internet Explorer™ browser). The web pages themselves are typically defined by hypertext markup language (“HTML”) code that provides a standard set of tags that specify how a web page is to be displayed. When a client desires to view a particular web page, the browser software sends a request to the server 16 to transfer to the client computer 14 an HTML document that defines the web page. When the requested HTML document is received by the client computer 14, the browser displays the web page as defined by the HTML document. The HTML document typically contains various tags that control the displaying of text, graphics, user interface controls, and other functionality such as implementing queries or selecting items for purchase, for example. Additionally, the HTML document may contain URLs of other web pages available on the server 16 or other servers connected to the Internet 12.

Conventional computer systems 10, as described above, allow researchers located in different geographic locations to access and search genetic databases. Typically, a genetic database stores information in a relational format. Such a relational database supports a set of operations defined by relational algebra and generally includes tables composed of columns and rows for the data contained in the database. Each table may have a primary key, being any column or set of columns containing values which uniquely identify the rows in the table. The tables of a relational database may also include a foreign key, which is a column or set of columns the values of which match the primary key values of another table. A relational database is also generally subject to a set of operations (select, join, divide, insert, update, delete, create, etc.) which form the basis of the relational algebra governing relations within the database.

Using the system 10 described above, a client can search for information in a genetic database, that stores information in a relational format, as follows. In response to a http request received by a client computer 14, the server computer 16 will provide at least one HTML web page to the client computer 14. At the client computer 14, the HTML web page provides a user interface which is employed by the user to formulate his or her requests for access to database 18. That request is converted by web application software within the server to a structured query language (SQL) statement. This SQL query is then used by database management software executed by the server 16 to access the relevant data in database 18. The server 16 then generates a new HTML web page that contains the requested database information.

Structured Query Language (SQL) is well-known in the art and according to ANSI (American National Standards Institute), is the standard language for relational database management systems. SQL statements are used to perform tasks such as update data on a database, or retrieve data from a database. Some common relational database management systems that use SQL are: Oracle, Sybase, Microsoft SQL Server, Access, Ingres, etc. Although most database systems use SQL, most of them also have their own additional proprietary extensions that are usually only used on their system. However, the standard SQL commands such as “Select”, “Insert”, “Update”, “Delete”, “Create”, and “Drop” can be used to accomplish most functions. Client/server environments, database servers, relational databases and networks that utilize SQL are well known and documented in the technical, trade, and patent literature. For a discussion of database servers, relational databases and client/server environments generally, and SQL servers particularly, see, e.g., Nath, A., The Guide to SQL Server, 2nd ed., Addison-Wesley Publishing Co., 1995, which is incorporated by reference herein in its entirety.

In the field of genetics, one of the primary tools used by researchers today is the computer. Today's researchers require advanced quantitative analyses, database searches and comparisons, and computational algorithms to explore the relationships between particular nucleic acid sequences and particular traits, diseases, behaviors, phenotypes, species, etc. This merging of computer-based technologies with biotechnology is commonly referred to as bioinformatics. Today and in the future, bioinformatics techniques are and will be indispensable to conducting genetic research.

A rapidly growing field of bioinformatics is the study genetic diversity. With the human genome now determined, or sequenced, the degree and nature of this genetic diversity represents a rich field of scientific inquiry. One area of intense study, for example, is how some of the differences in DNA (called “polymorphisms”) can effect a person's susceptibility to disease and/or response to drugs. Technology is available to measure DNA differences at the single nucleotide base level. Single nucleotide differences in DNA, known as “single nucleotide polymorphisms” (“SNPs”), are thought by many scientists to represent the most common form of genetic diversity. While much progress has been made in conducting SNP research, this field is still in its infancy and further improvements in genetic data processing and relational database systems will expedite the advancement of SNP research for numerous applications.

Public SNP databases are currently being maintained by public entities such as the National Center for Biotechnology Information (NCBI), a department of the National Institute of Health (NIH), and the SNP consortium, a group of private and public entities which have collected and stored SNP data in a public database maintained at Cold Spring Harbor Laboratory, located at Cold Spring Harbor, N.Y., U.S.A. These organizations have stored large quantities of SNP data into SNP databases that are made accessible to researchers for free. Other private companies such as Incyte Pharmaceuticals, Inc. of Palo Alto, Calif., U.S.A., for example, have also collected and stored SNP data in private databases that customers may access for a fee. These private SNP databases contain information and/or searching functionality that is not available in the public database systems. Because these private database systems were developed at considerable expense, researchers desiring access to these private databases, are typically required to pay a large lump sum and/or monthly fee. Companies who can afford to pay these large fees are granted unlimited access to the private database. In other words, the fees have no rational relationship to the amount or kind of data retrieved from the database. Thus, prior art business models for providing access to private SNP databases are not well-suited for smaller research companies desiring to search for and obtain only specifically relevant information pertaining to relatively small research projects.

Other known methods and systems, such as that described in International Application No. PCT/IB01/00468, published Sep. 20, 2001, allow customers to order custom biologicals (e.g., genetic data or biological products such as oligonucleotide primers) by submitting a request for bids for such data or products via a computer network (e.g., LAN, WAN or Internet). The request is received by an online transaction server which then submits the order to multiple vendors that may be able to fulfill the request or order. The vendors who have access to genetic databases or the biological products requested by a customer then return bids or price quotes for fulfilling the request or order. Typically, the customer will then select the lowest bid or price quote. Although this system allows researchers to obtain genetic data in a cost-effective manner, it is severely limited in its utility to researchers because they are never granted access to the genetic database. Thus, researchers cannot perform the extremely important function of searching genetic databases to determine what information may be relevant to their research or what information may even be available. In this system, it is a prerequisite that the customer already knows the specific type of data he or she desires to obtain.

Additionally, existing public and private database systems do not monitor what information is obtained from the database, nor by which researcher/client. This adds to the inefficiency and costs of using existing systems. Often times, researchers search for and obtain the same data that has been obtained from previous queries or for previous research projects. Additionally, in situations where multiple employees from a single company or organization, can access a database, such employees may obtain the same information as previously obtained by other employees, without ever being aware of the information that has been obtained previously by another employee in the same company. Thus, data already obtained by others within the same organization, may be unnecessarily obtained many times over from the database. This is wasteful from the perspective of both the vendor server and database resources as well as the client company's resources and time.

One area of SNP research that is vitally important is the process of designing and creating assays for performing diagnostic tests on sequences known or believed to contain one or more SNPs. These assays utilize oligonucleotides which are designed to hybridize to test sequences at high stringency. Such oligonucleotides, otherwise referred to herein as “primers,” are well-known in the art. Primer extension-based nucleic acid sequence detection methods are disclosed, for example, in U.S. Pat. Nos. 4,656,127; 4,851,331; 5,679,524; 5,834,189; 5,876,934; 5,908,755; 5,912,118; 5,976,802; 5,981,186, 6,004,744; 6,013,431; 6,017,702; 6,046,005; 6,087,095; 6,210,891; and WO 01/20039. Primer extension-based nucleic acid sequence detection methods using mass spectrometry are described, for example, in U.S. Pat. Nos. 5,547,835; 5,605,798; 5,691,141; 5,849,542; 5,869,242; 5,928,906; 6,043,031; and 6,194,144. Oligonucleotides are also suitable for use in ligase-based sequence determination methods such as those disclosed in U.S. Pat. Nos. 5,679,524 and 5,952,174, and WO 01/27326. Oligonucleotides may also be used as probes in sequence determination methods based on mismatches, such as the methods described in U.S. Pat. Nos. 5,851,770; 5,958,692; 6,110,684; and 6,183,958. In addition, oligonucleotides may be used in hybridization-based diagnostic assays such as those described in U.S. Pat. Nos. 5,891,625 and 6,013,499. These references are incorporated by reference herein in their entireties.

Heretofore, no prior SNP database systems have correlated and stored assay data with SNP data in one or more databases that are searchable by clients. Additionally, prior SNP database systems have not allowed researchers to search for SNP data meeting multiple search criteria and, thereafter, purchase only desired data (e.g., sequence and/or assay data) pertaining to selected SNPs.

In view of the above deficiencies of prior art systems and methods, there exists a need for a method and system that allows clients to access a genetic database, search for information based on desired criteria, and, thereafter, purchase only selected information. Additionally, there exists a need for a method and system that monitors and stores data purchased by individuals, or by multiple individuals belonging to a single organization or company, so that previously purchased data is available to such individuals and redundant purchase requests are ignored.

### SUMMARY OF THE INVENTION

The invention addresses the above and other needs by providing a genetic database system that displays search results, meeting a client's search criteria, in a first genetic data format that allows the client to determine which search result “hits” he or she is interested in. In a preferred embodiment, the search and display of search results in the first genetic data format is free to the client. However, if the client desires to obtain additional information or data pertaining to selected search result hits, the client must purchase this additional information for a specified fee. Thus, the method and system of the present invention, allows researchers to search the genetic database, determine what information is available and, thereafter, purchase only desired or specifically relevant information. This is a much more targeted and efficient model for providing access to genetic data than has previously been implemented by other genetic database systems.

In a preferred embodiment, the invention provides a SNP database system that allows clients to search for SNPs meeting one or more specified criterion. Search criteria may include, for example, chromosome number, gene, population (e.g., CEPH, African, Asian, etc.), keywords, and/or assay status (e.g., working validated assays are available or not available for purchase). The system thereafter displays search result hits in a first genetic data format that allows the client to determine whether he would like to purchase additional information pertaining to the one or more search result hits. The client can thereafter purchase additional information (e.g., sequence and/or assay data) for only those SNPs that the client selects. It is appreciated that the first genetic data format for displaying SNP search result hits is designed to provide enough information for the client to make selections but does not provide essential data (e.g., public SNP ID, sequence, assay information) which would make the purchase of additional information unnecessary. In one embodiment, the first genetic data format includes: an internal SNP Code, used for internal identification purposes; a chromosome number indicating on which chromosome the SNP was found; a chromosome band; locus information; allele information; allele frequency; population; and polymorphic/non-polymorphic status information.

Another aspect of the invention provides a relational database containing SNP data indexed and correlated with various search criteria, as well as SNP sequence and/or assay information pertaining to each respective SNP. Thus, researchers may immediately purchase in real-time sequence and/or assay information for selected SNPs.

In another embodiment, the purchase of additional SNP data automatically debits a credit account that is maintained by the SNP database system for the respective client or company. Additionally, the SNP database system maintains a personal SNP file for each researcher that has access privileges to the SNP database. This personal SNP file contains all SNP data previously purchased by a respective researcher. If a researcher submits a purchase request for SNP data that has been previously purchased, perhaps in connection with a completely different research project, the database system will ignore the purchase request and notify the researcher that duplicate data has been ordered. In this case, the credit account is not debited for that duplicate data.

In another aspect of the invention, the SNP database system also maintains an organizational SNP file for an organization of company that has multiple employees having access privileges to the database. This organizational SNP file contains all SNP data previously purchased by all employees/researchers belonging to the same organization. If any employee submits a purchase request for SNP data that has previously been purchased by any employee in the company, the database system will ignore the purchase request and notify the researcher that duplicate data has been ordered. In this case, the credit account for the company is not debited for that duplicate data.

### BRIEF DESCRIPTION OF THE DRAWINGS

FIG. 1 illustrates a prior art computer system that may be used by clients to search for and retrieve data from a database via the Internet.

FIG. 2A illustrate a relational database table schema for storing SNP data, in accordance with one embodiment of the invention.

FIG. 2B illustrates an exemplary table format for one of the tables represented in the table schema of FIG. 2A, in accordance with one embodiment of the invention.

FIG. 3 illustrates an exemplary web page configured to provide a user interface for conducting searches of a SNP database, in accordance with one embodiment of the invention.

FIG. 4A illustrates an exemplary web page for conducting a simple search based on a “gene symbol first letter” query, in accordance with one embodiment of the invention.

FIG. 4B illustrates an exemplary web page for conducting a simple search based on a “gene symbol” query, in accordance with one embodiment of the invention.

FIG. 5 illustrates an exemplary web page for conducting a simple search based on a “Blast” query, in accordance with one embodiment of the invention.

FIG. 6 illustrates an exemplary web page for conducting a simple search based on a “SNP ID” query, in accordance with one embodiment of the invention.

FIG. 7 illustrates an exemplary web page for conducting a simple search based on a “third party ID” query, in accordance with one embodiment of the invention.

FIG. 8 illustrates the exemplary web page of FIG. 1 configured for an advanced search using “SNP assay” type as one search criteria, in accordance with one embodiment of the invention.

FIG. 9 illustrates the exemplary web page of FIG. 1 configured for an advanced search using “population” type as one search criteria, in accordance with one embodiment of the invention.

FIG. 10 illustrates the exemplary web page of FIG. 1 configured for an advanced search using “gene symbol” as one search criteria, in accordance with one embodiment of the invention.

FIG. 11 illustrates the exemplary web page of FIG. 1 configured for an advanced search using a “gene keyword” as one search criteria, in accordance with one embodiment of the invention.

FIG. 12 illustrate an exemplary web page containing search results for SNPs associated with a particular chromosome (e.g., chromosome 16), in accordance with one embodiment of the invention.

FIG. 13 illustrates an exemplary web page containing a graphic representation of SNP information pertaining to a particular chromosome (e.g., chromosome 16), in accordance with one embodiment of the invention.

FIG. 14 illustrate an exemplary web page containing search results for SNPs associated with a gene keyword (e.g., “cancer”), in accordance with one embodiment of the invention.

FIG. 15 illustrates an exemplary web page containing a graphic representation of SNP information pertaining to a particular chromosome (e.g., chromosome 13) and associated with a gene keyword (e.g., “cancer”), in accordance with one embodiment of the invention.

FIG. 16 illustrates an exemplary “pop-up” window confirming the purchase of SNP data, in accordance with one embodiment of the invention.

FIG. 17 illustrates an exemplary “Personal SNP” web page containing SNP information purchased by an individual researcher, in accordance with one embodiment of the invention.

FIG. 18 illustrates an exemplary web page containing SNP sequence information for a SNP selected from the “Personal SNP” web page of FIG. 17, in accordance with one embodiment of the invention.

FIG. 19 illustrates an exemplary web page containing SNP assay information for a SNP selected from the “Personal SNP” web page of FIG. 17, in accordance with one embodiment of the invention.

FIG. 20 illustrates an exemplary “Organization SNP” web page containing SNP information purchased by all individuals from a single organization, in accordance with one embodiment of the invention.

### DETAILED DESCRIPTION OF THE PREFERRED EMBODIMENTS

The invention, in accordance with various preferred embodiments, is described in detail below with reference to the figures. The invention provides a method and system for searching for and purchasing information pertaining to genetic polymorphisms, via a computer network (e.g., the Internet). As used herein, the term “genetic polymorphism” refers to a region in a nucleic acid at which two or more alternative nucleotide sequences have been observed in nucleic acid samples from a population of individuals. A genetic polymorphism may be a nucleotide sequence of one or more nucleotides, an inserted nucleotide or nucleotide sequence, a deleted nucleotide or nucleotide sequence, or a microsatellite, for example. A genetic polymorphism comprising only one nucleotide is referred to herein as a “single nucleotide polymorphism” or a “SNP.” Although the preferred embodiments are described in the context of searching and purchasing SNP information from a prototype website (“RealSNP.com”), developed by Sequenom, Inc. of San Diego, Calif., it is readily apparent to those of ordinary skill in the art that the invention may be advantageously utilized to search for and purchase information pertaining to genetic polymorphisms, in general, and other types of genetic information. These additional implementations are intended to be within the scope of the invention described herein.

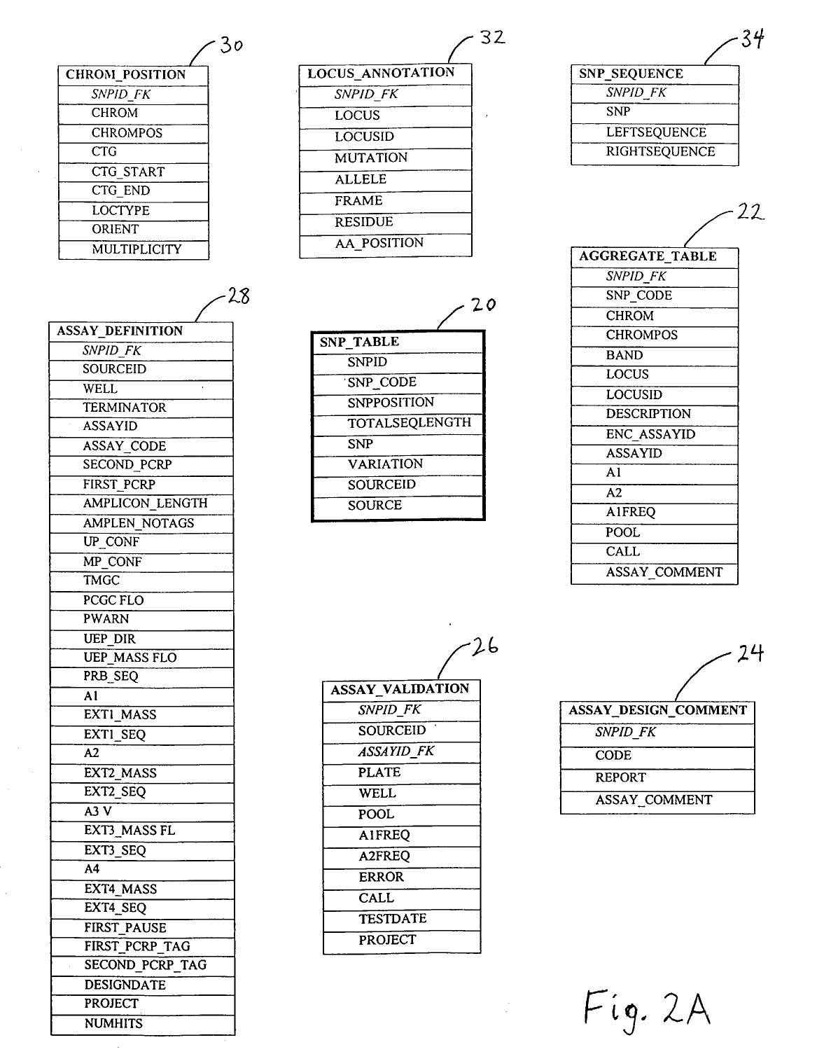

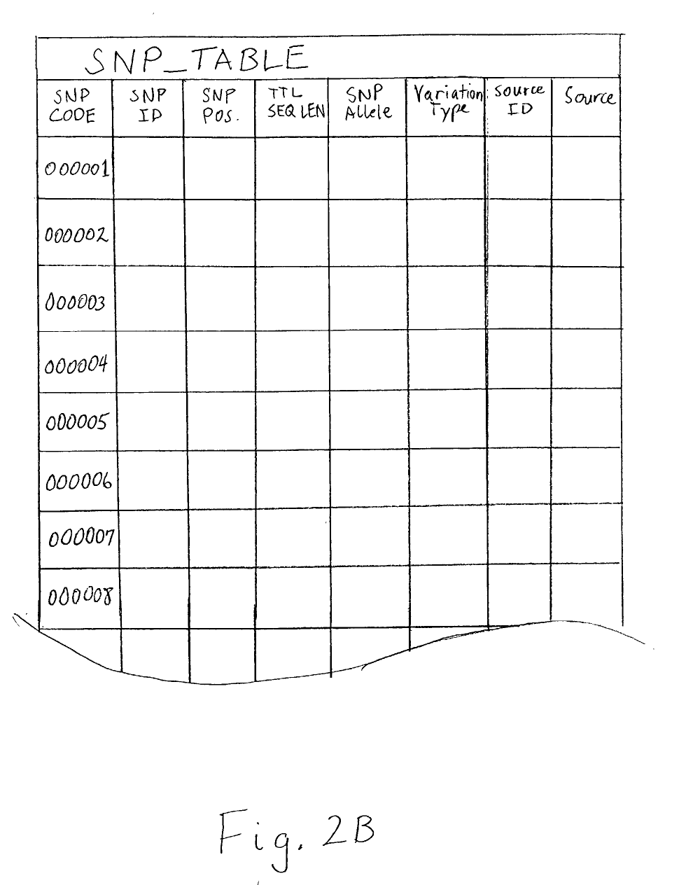

FIG. 2A illustrates an exemplary table schema for a relational database containing SNP information, in accordance with a preferred embodiment of the invention. The table schema includes a master SNP table 20 which contains identification information such as SNP ID, SNP Code, SNP Position, Total Sequence Length, SNP alleles, Variation type, Source ID, and Source (of information) for each SNP contained in the database. As would be understood by those of skill in the art, the table schema identifies the categories of information that would be available for each SNP in the database. Thus, each of the categories of identification information constitute a column in the actual table of the relational database, as shown in FIG. 2B. Referring to FIG. 2B, a row of the table is allocated for each SNP stored in the database wherein for each row there is a data entry under each column category. In a preferred embodiment, SNPs are randomly sorted into the table and, thereafter, assigned sequential internal SNP Codes which are used as identification parameters that are shown to customers. Alternatively, as would be apparent to one of ordinary skill in the art, these SNP Codes may also be used for internal data correlation purposes.

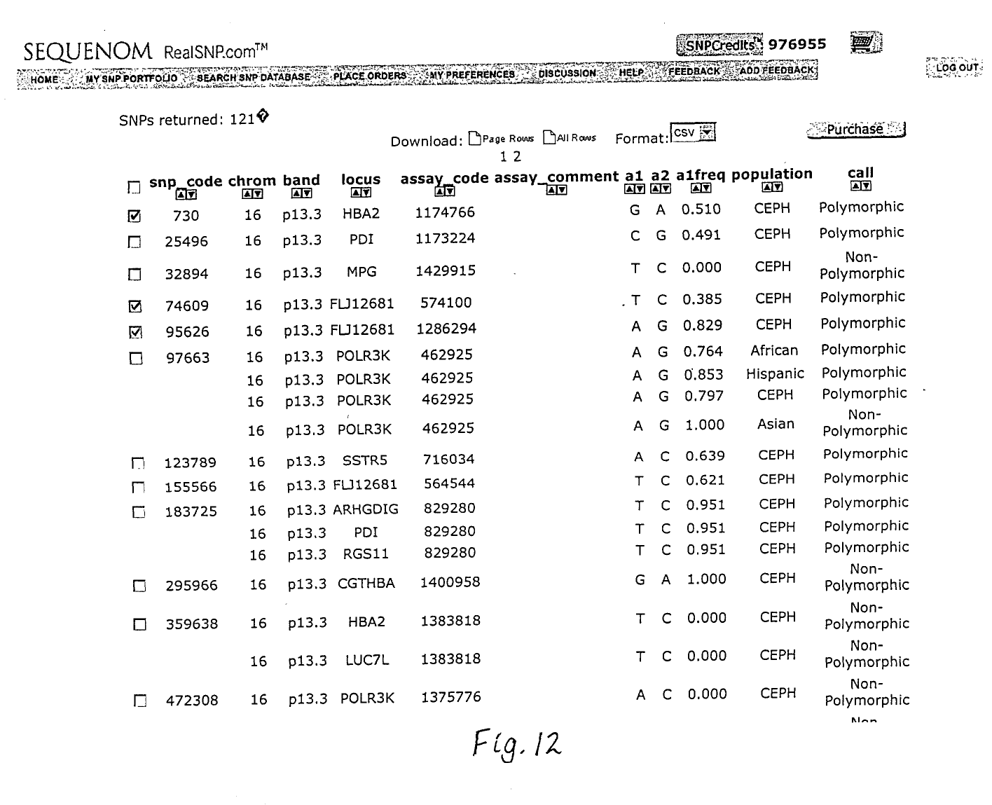

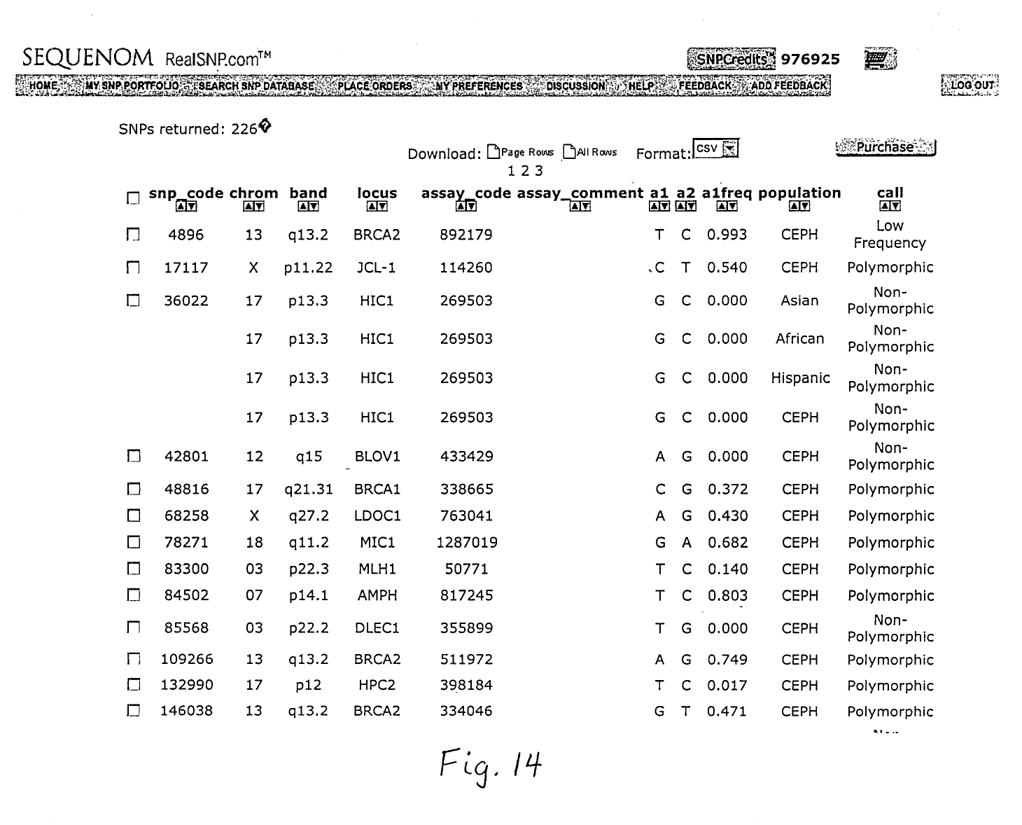

Referring again to FIG. 2A, the table schema further includes other tables formatted similarly as the SNP table 20 which contain additional information associated with the SNPs identified in table 20. An “Aggregate Table” 22 contains exemplary general information about each SNP that would be displayed in a first genetic data format for displaying SNP query search results, explained in further detail below with reference to FIGS. 12 and 14. The Aggregate Table 22 contains a foreign key (FK), which in this example is associated with the SNP ID, that is used to correlate the information contained in table 22 with corresponding information contained in table 20 (i.e., information for a SNP containing the same SNP ID). Thus, information in table 22 is “linked” with information in table 20 having a common SNP ID value associated with the information.

The table schema further includes an “Assay Design Comment” table 24, which contains information pertaining to assays for each SNP stored in the database such as assay ID's, assay availability, and further comments and information about respective assays, as may be provided by the SNP database vendor. As shown in FIG. 2A, table 24 also has a SNP ID foreign key (FK) and, thus, is associated with the master table 20 and other tables in the schema, as described above.

The table schema further includes an “Assay Validation” table 26 which contains information about validated assays made available by the vendor and stored in the SNP database. This table also has a SNP ID foreign key to correlate its information with information contained in other tables in the database. An “Assay Definition” table 28 contains more specific information about SNP assays that may be provided by the vendor and also utilizes a SNP ID foreign key for correlation purposes. A “Chrom Position” table 30 contains information about respective chromosome positions associated with each respective SNP contained in the master SNP table 20. Table 30 also utilizes a SNP ID foreign key. A “Locus Annotation” table 32 contains information about respective genes associated with each respective SNP and also utilizes a SNP ID foreign key. Finally, a “SNP Sequence” table 34 contains SNP sequence information pertaining to each respective SNP and also utilizes a SNP ID foreign key.

In a preferred embodiment, each of the tables represented in the table schema contains data in a format similar to that for the master SNP table shown in FIG. 2B. As would be apparent to those of ordinary skill in the art, however, each of these tables may contain any number and variety of information pertaining to each SNP as may be determined, developed or desired by a SNP database vendor. Additional and/or different arrangements of information may be added to the tables shown in FIG. 2A or new tables created in accordance with any relational format desired by the vendor. Thus, it is understood that the tables, the categories of information in each table, and the relational linking between the tables illustrated in FIGS. 2A and 2B are exemplary only and should not limit the scope of the invention disclosed herein.

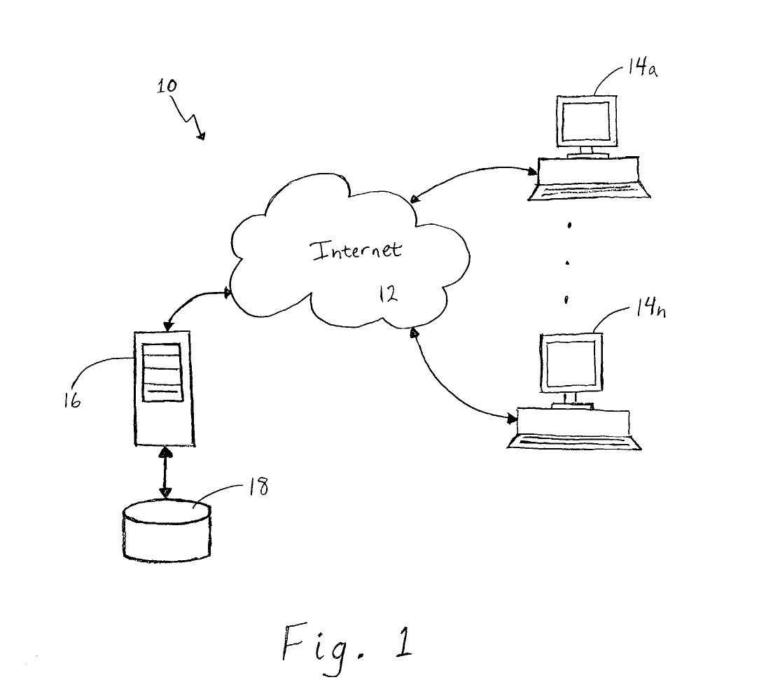

In a preferred embodiment, the invention provides a computer-based method and system that allows client researchers, located at different geographic areas, to search for and purchase SNP information via the Internet 12 (FIG. 1). In a preferred embodiment, each client researcher can access a SNP database via the Internet 12 by logging in at a home page of a SNP database vendor (e.g., RealSNP.com), in accordance with communication protocols well-known in the art. In a preferred embodiment, only client researchers or companies that have registered an account with the database owner or vendor, and have assigned to them appropriate login and passcode information, are granted access to the SNP database.

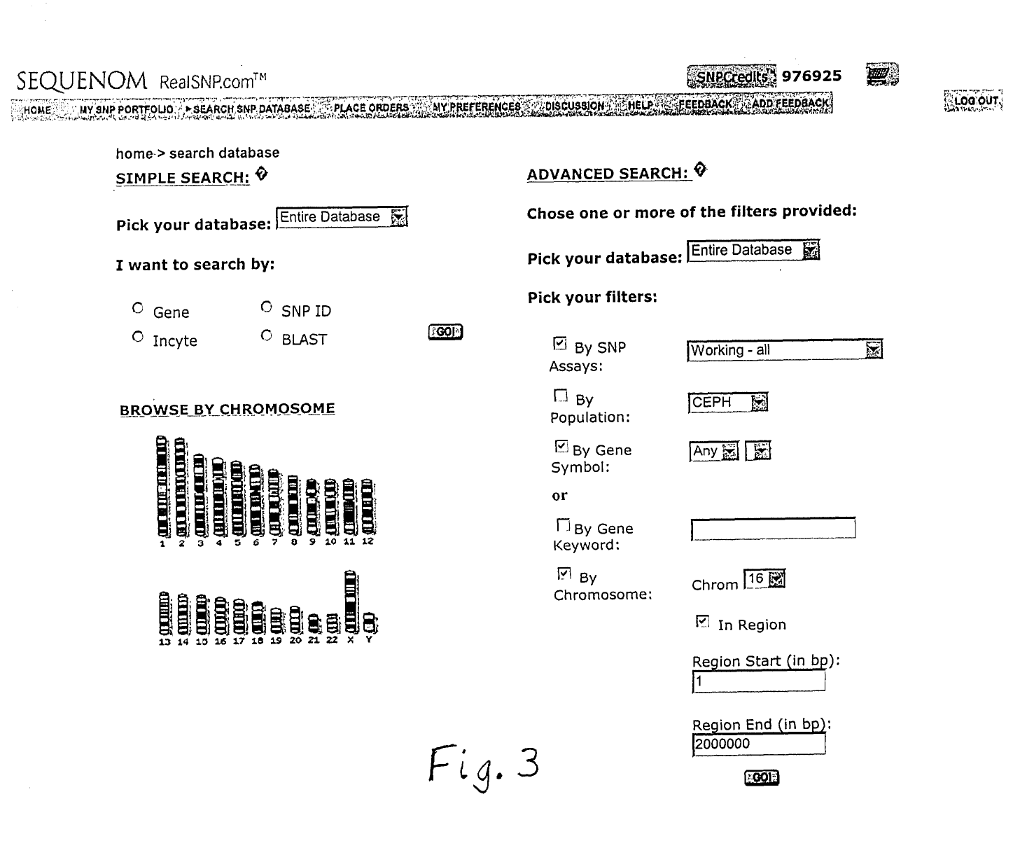

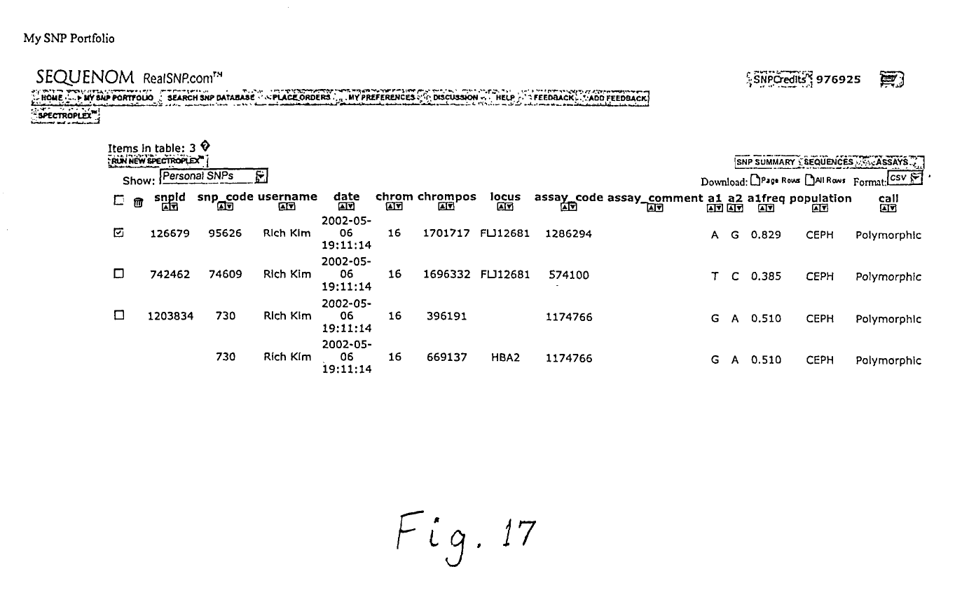

After a user submits appropriate login and passcode information at the vendor home page, he or she can select or click on a “search SNP database” icon, using a graphic pointing device (e.g., a “mouse”), for example, which retrieves a search page as shown in FIG. 3. As shown in FIG. 3, the search page allows the user to conduct “simple searches” as well as “advanced searches” based on a variety of criteria. When conducting either simple or advanced searches, the user can select to search the entire SNP database or only a portion of the database (e.g., “Personal SNPs” or “Organizational SNPs”) as explained in further detail below with respect to FIGS. 17-20. In one embodiment, a plurality of different database choices are provided to the user to allow the user to select one or more of the available databases to conduct searches and purchase information contained in the selected databases, as described in further detail below.

In one embodiment, a user can conduct a “simple search,” by specifying Gene, SNP ID, Blast, or third party (e.g., Incyte) SNP reference parameters, as search criteria. The user can also select to search for SNPs associated with a particular chromosome of the human genome. In order to conduct a search based on one of these criteria, the user can simply select an appropriate category (e.g., “Gene,” “SNP ID,” “Blast”, “Incyte”) and then click on a “GO!” button provided by the user interface page. Alternatively, the user can simply click on a chromosome, as shown in FIG. 3.

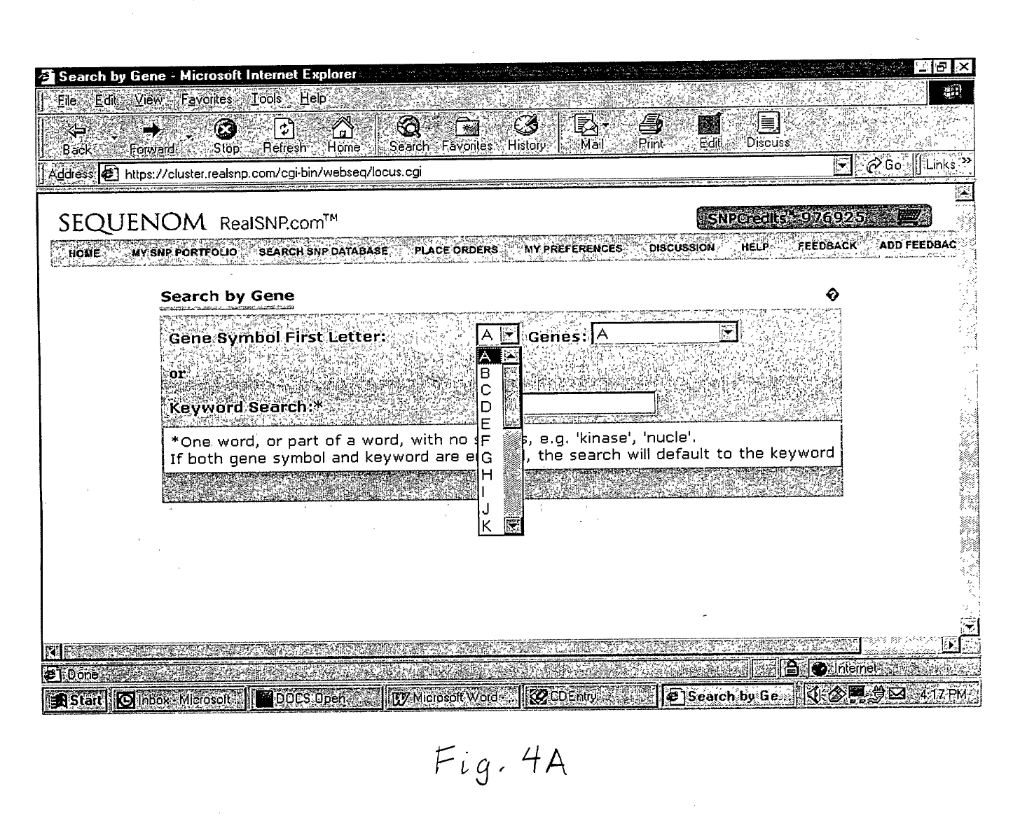

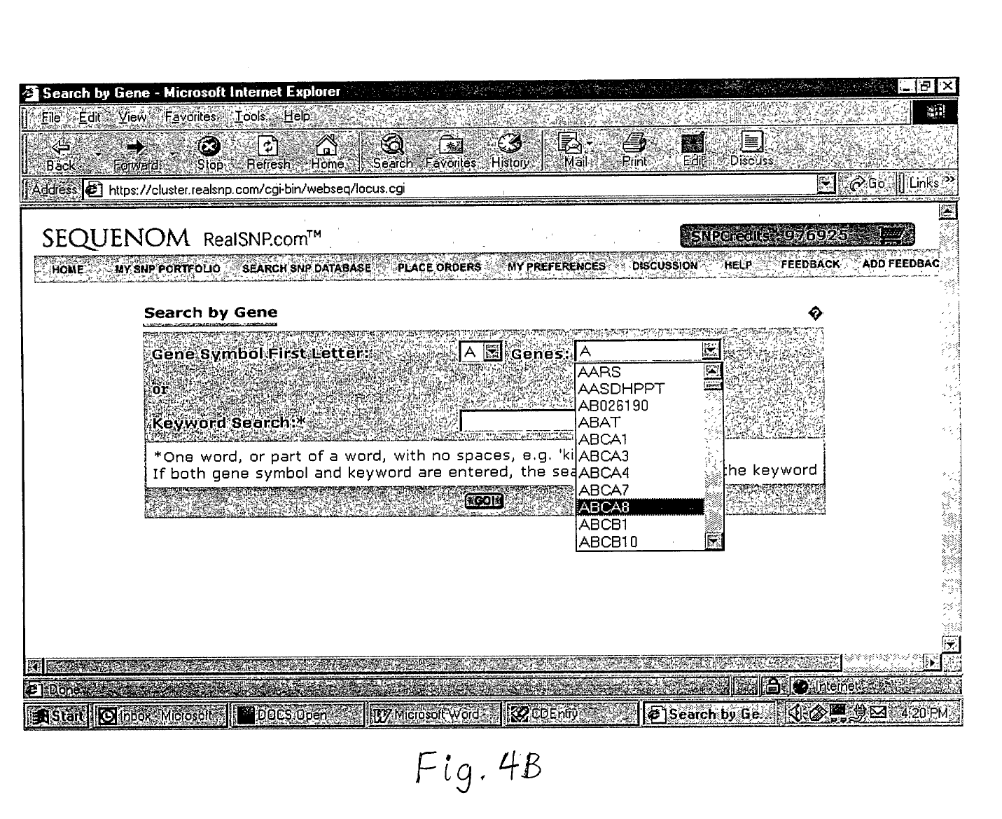

FIG. 4A illustrates an exemplary web page for conducting a “search by gene,” in accordance with one embodiment of the invention. The page includes a “pull-down” window that provides a menu of gene symbol first letters that are well-known and recognized by those of ordinary skill in the art. As shown in FIG. 4A, the user may then select any letter in the range of A-Z to search for all SNPs associated with genes having a gene symbol that starts with the selected letter. Referring to FIG. 4B, the user can also search for all SNPs associated with a particular gene, by selecting an entire gene symbol from a second pull-down menu provided by the “search by Gene” web page. Also, as shown in FIGS. 4A and 4B, the user may conduct a gene keyword search by entering a desired keyword and, thereafter, clicking a “GO!” button.

As described above with respect to FIG. 2, in a preferred embodiment, the SNP database is a relational database containing tables that are key indexed so as to correlate information contained in the respective tables. In one embodiment, a table (e.g., Locus Annotation table 32 of FIG. 2) contains information concerning genetic polymorphisms so as to allow a user to search for SNPs associated with genes by specifying a “gene symbol” or “gene symbol first letter” and/or “gene keyword.” In one embodiment, information concerning the relationship of SNPs with various genes and/or chromosomes may be obtained from public databases (e.g., GenBank, Ensembl), and then stored and indexed with an internal reference number (i.e., SNP Code) specific to the vendor SNP database in accordance with the table schema of FIG. 2.

Thus, in a preferred embodiment, searching by “Gene” is enabled by storing and correlating SNP information with the names of respective gene sequences which have previously been associated with respective SNPs, in accordance with relational key indexing techniques well-known in the art. The names or symbols of many genes are known and recognized by those of skill in the art. Such gene names and symbols are available from public databases such as “Locus Link” maintained by the NCBI or the “Hugo” database maintained by the Human Gene Nomenclature Committee. It is understood, however, that the invention is not limited to storing information pertaining only to human genes or SNPs but may include such information for any variety of species or organisms. In one embodiment, a simple database search based on gene symbol will identify genetic polymorphisms within a gene or within a specified range of base pairs from the 5′ start of a gene sequence or the 3′ end of a gene sequence.

Similarly, “gene keyword” searching is enabled by correlating SNP information with keyword descriptions or abstracts that have previously been created and compiled for respective SNPs, in accordance with relational key indexing techniques well-known in the art. In one embodiment, such descriptions and abstracts may be obtained from public SNP and other databases such as those created and maintained by NCBI. When performing a keyword search, each of these descriptions/abstracts are searched to determine which SNPs are associated with the keyword entered by the user. The SNP search results are then displayed to the user in a first genetic data format described in further detail below with respect to FIGS. 12-15.

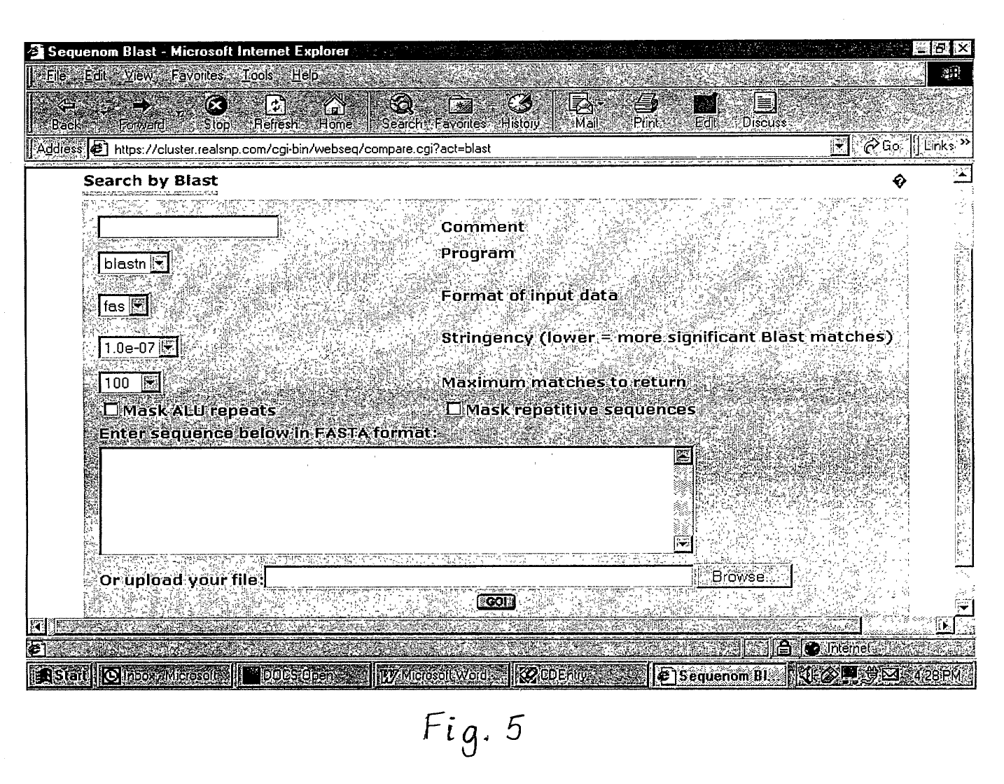

FIG. 5 illustrates an exemplary web page for conducting a search for SNPs based on a Blast query. Using the web page shown in FIG. 5, the user may enter a nucleotide sequence and search for a substantially similar nucleotide sequence present in the database and, thereafter, obtain a list of SNPs that have been associated or linked with the database sequence. This type of search may be performed using the NBLAST program (version 2.0) of Altschul, et al., J. Mol. Biol. 215:403-410 (1990), the entirety of which is incorporated by reference herein. In another embodiment, to obtain gapped alignments for comparison purposes, Gapped BLAST can be utilized as described in Altschul et al., Nucleic Acids Res. 25(17):3389-3402 (1997), the entirety of which is incorporated by reference herein. When utilizing BLAST and Gapped BLAST programs, default parameters can also be used. For additional discussion or information regarding these programs, visit www.ncbi.nlm.nih.gov.

The term “substantially similar” when used herein with respect to nucleotide sequences refers to two or more nucleic acid molecules sharing one or more identical nucleotide sequences. One test for determining whether two nucleic acids are substantially similar is to determine the percent of identical nucleotide sequences shared between the nucleic acids. Calculations of sequence identity are often performed as follows. The sequences are aligned for optimal comparison purposes (e.g., gaps can be introduced in one or both of a first and a second amino acid or nucleic acid sequence for optimal alignment and non-homologous sequences can be disregarded for comparison purposes). The length of a sequence aligned for comparison purposes may be any desired percentage (e.g., 30% to 100%) of the length of the reference sequence. The nucleotides at corresponding nucleotide positions are then compared among the two sequences. When a position in the first sequence is occupied by the same nucleotide as the corresponding position in the second sequence, the molecules are deemed to be identical at that position. The percent identity between the two sequences is a function of the number of identical positions shared by the sequences, taking into account the number of gaps, and the length of each gap, introduced for optimal alignment of the two sequences. Next, a further step for judging the similarity of sequences includes calculating the statistical significance of their percent identity. Known BLAST algorithms and other alignment programs provide measures of this significance.

Comparison of sequences and determination of percent identity between two sequences can be accomplished using known mathematical algorithms. For example, percent identity between two nucleotide sequences can be determined using the GAP program in the GCG software package available at www.gcg.com, or using a NWSgapdna.CMP matrix and a gap weight of 40, 50, 60, 70, or 80 and a length weight of 1, 2, 3, 4, 5, or 6, for example. A set of parameters often used is a Blossum 62 scoring matrix with a gap open penalty of 12, a gap extend penalty of 4, and a frameshift gap penalty of 5. Various methods and programs for determining sequence identity or similarity are known in the art. Any one of these methods and programs may be utilized in accordance with the present invention.

After one or more sequences are identified that are identical or substantially similar to the Blast sequence entered by the user, application software executed by a database server computer performs a search of the SNP database for SNPs associated with the one or more sequences. The SNP search results are then displayed to the user in a first genetic data format described in further detail below with respect to FIGS. 12-15.

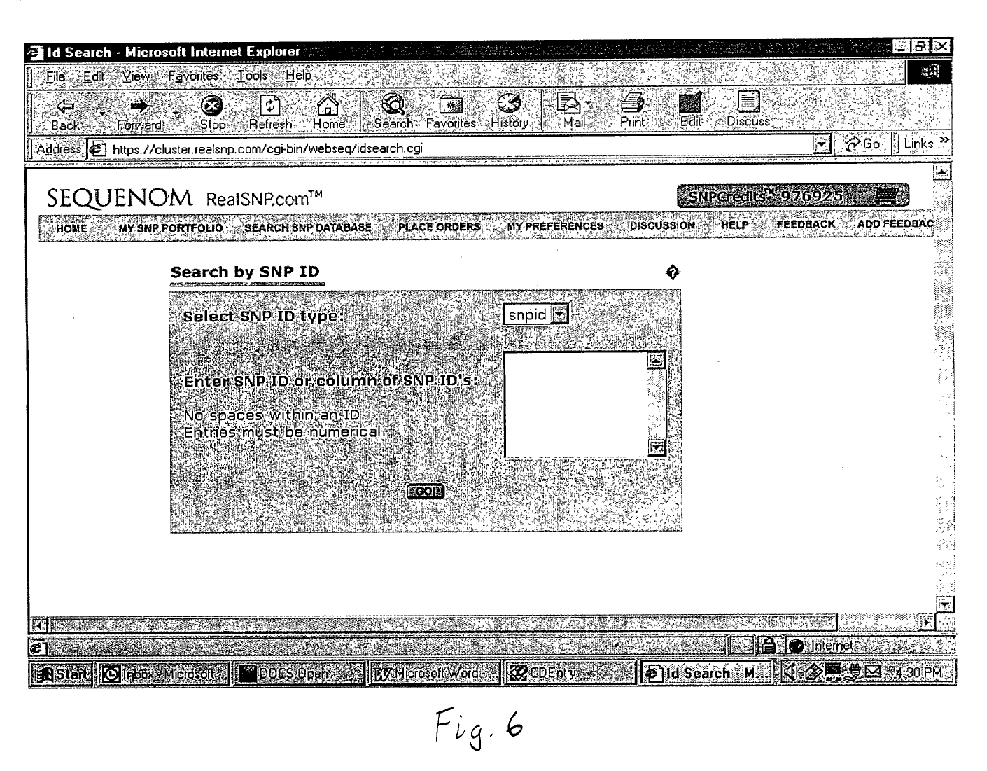

FIG. 6 illustrates an exemplary web page presented to the user for conducting a SNP search based on known SNP ID numbers. In a preferred embodiment, known and generally accepted SNP ID numbers available from public databases, such as those created and maintained by NCBI and the SNP consortium, are correlated to SNP data contained in the SNP database in accordance with relational key indexing techniques well-known in the art and described above with respect to FIG. 2. Thus, the user can enter these “public” SNP ID numbers to obtain further information for corresponding SNPs that may be available from the private SNP database of the present invention.

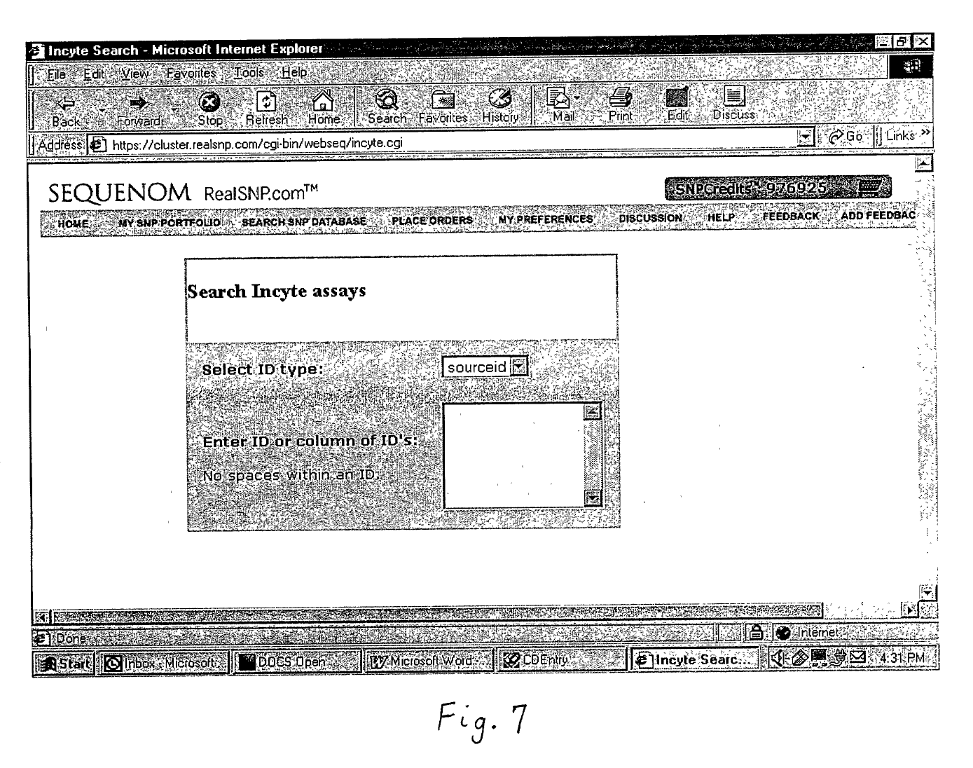

Similarly, SNP ID numbers which have been assigned to various SNPs by third party private vendors (e.g., Incyte Pharmaceuticals) may also be correlated with SNP data in the SNP database of the invention. FIG. 7 illustrates an exemplary web page that is presented to users to conduct a SNP search based on third party SNP reference numbers. As shown in FIG. 7, the web page provides an input window wherein Incyte ID numbers, for example, may be entered as search criteria. Thus, users who have previously obtained SNP information from third party databases may search for and obtain further information pertaining to these same SNPs that is available in the present vendor's SNP database. In this way, many private companies who own and maintain private databases may collaborate to provide clients with enhanced information and research tools.

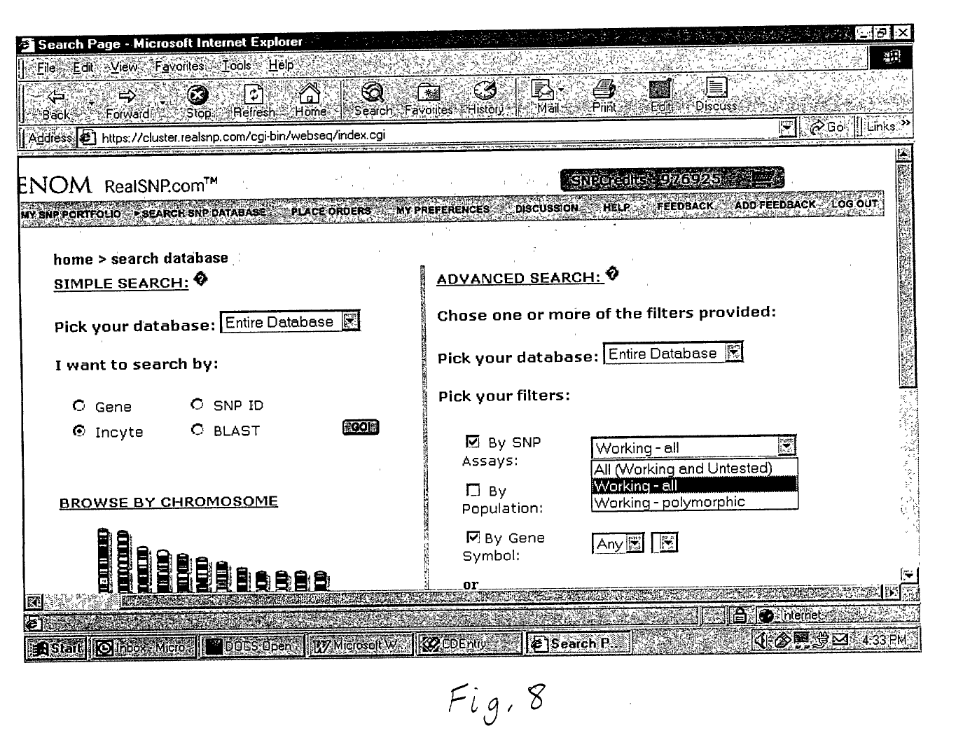

FIG. 8 illustrates the exemplary web page of FIG. 3 configured for an advanced search using “SNP assay” type as one search criteria, in accordance with one embodiment of the invention. As shown in FIG. 8, the advanced search user interface provides a pull-down menu that allows a user to specify assay criteria for performing a SNP search. The user can select “All (working and untested)” which includes SNPs for which working and tested assays have been developed as well as SNPs for which working and tested assays are not available. These types of assays are also referred to herein as validated and non-validated assays, respectively. Alternatively, the user may select “Working—all” which includes SNPs for which validated assay information is available from the SNP database. As a third choice, the user can specify “Working—polymorphic” which will include only those SNPs which have been confirmed as polymorphic and for which validated assay information is available from the SNP database. The relational SNP database of the invention correlates SNP data with each of these SNP assay categories so as to allow searching based on these criteria.

As used herein, the term “polymorphic” refers to those SNPs which have been experimentally confirmed to be genetically polymorphic, as defined earlier in this document, in the populations, samples or groups tested. Where there are two alternative nucleotide sequences for a genetic polymorphism and one is represented in a minority of samples from a population, a nucleic acid comprising the rarer polymorphic nucleotide sequence is referred to herein as the “minor allele” and a nucleic acid comprising the more prevalent polymorphic nucleotide sequence is referred to herein as the “major allele.” Most organisms (e.g., humans) possess a copy of each chromosome and those individuals who possess two major alleles or two minor alleles are referred to herein as being “homozygous” for the polymorphism and those individuals who possess one major allele and one minor allele are referred to herein as being “heterozygous” for the polymorphism. Individuals who are homozygous with respect to one allele are sometimes predisposed to a different phenotype as compared to individuals who are homozygous with respect to the other alleles. Additionally, homozygotes with respect to one allele may have a different phenotype than homozygotes with respect to the other allele.

As used herein, the term “phenotype” refers to a trait which can be compared between indviduals, such as presence or absence of a disease, a visually observable difference in appearance between individuals, metabolic variations, physiological variations, variations in the function of biological molecules, and the like. The term “organism” as used herein refers to a virus (e.g., HIV), a single cell creature (e.g., bacteria, yeast, fungi, algae), and multicellular creatures (e.g., plants, insects, mammals). In a preferred embodiment, the SNP database includes genetic information relating to genomic nucleotide sequences from humans. It is understood, however, that the SNP database of the present invention is not limited to containing only human genetic information but may contain such information for any variety of organisms or species.

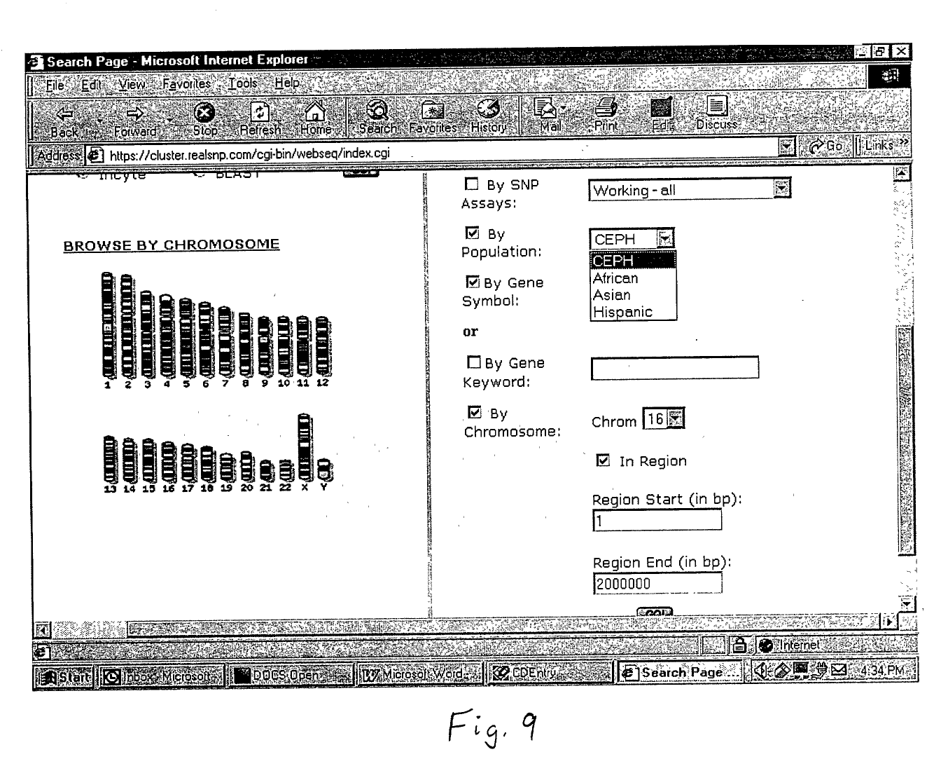

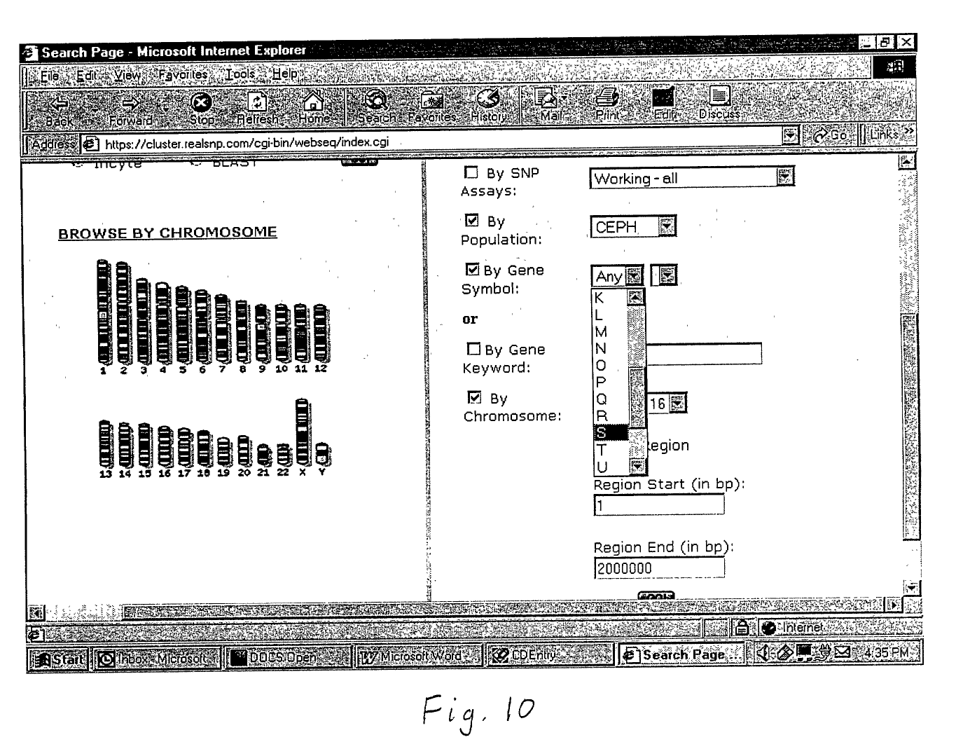

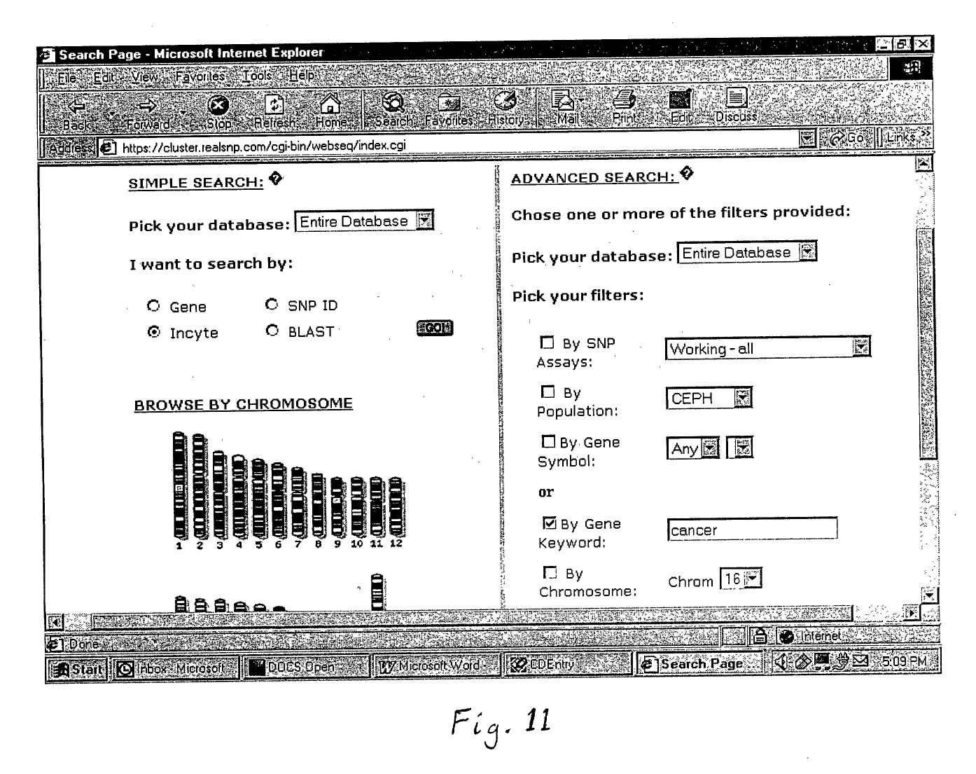

FIGS. 9-11 illustrate additional search criteria that may be specified by the user when conducting an advanced search. Referring to FIG. 9, the user may also enter criteria concerning population type or ethnicity. In a preferred embodiment, the advance search interface provides a pull-down menu from which the user may select from among a plurality of population choices such as CEPH, African, Asian, Hispanic, where CEPH generally refers to the Caucasian population. FIG. 10 illustrates a pull-down menu for selecting a “gene symbol” criterion for conducting an advanced search. FIG. 11 illustrates additional criteria such as gene keywords (e.g., “cancer”) and chromosomes (e.g., chromosome 16) that may be entered by the user. Referring again to FIG. 10, the user can also specify a region of a chromosome to search, e.g., the first two million (1 to 2,000,000) base pairs.

As described above, the invention provides a method and system for allowing users to search for SNP data in a variety of ways via the Internet. The user can conduct simple searches for SNPs meeting a single search criterion, or advanced searches for SNPs meeting multiple criteria. FIG. 12 illustrates a single screen shot (i.e., portion) of an exemplary web page displaying search results, in a first genetic data format, for SNPs meeting search criteria including “SNPs associated with chromosome 16,” in accordance with one embodiment of the invention. In a preferred embodiment, the first genetic data format includes a SNP Code which is a unique private code assigned to each respective SNP contained in the database and which may be used to correlate additional data associated with each SNP. In this preferred embodiment, the first genetic data format for displaying SNP search results further includes the following information associated with each SNP: chromosome number; chromosome band; locus; an assay code for correlating assay information (if available) with each respective SNP; SNP alleles; allele frequency; population information; and polymorphic vs. non-polymorphic status.

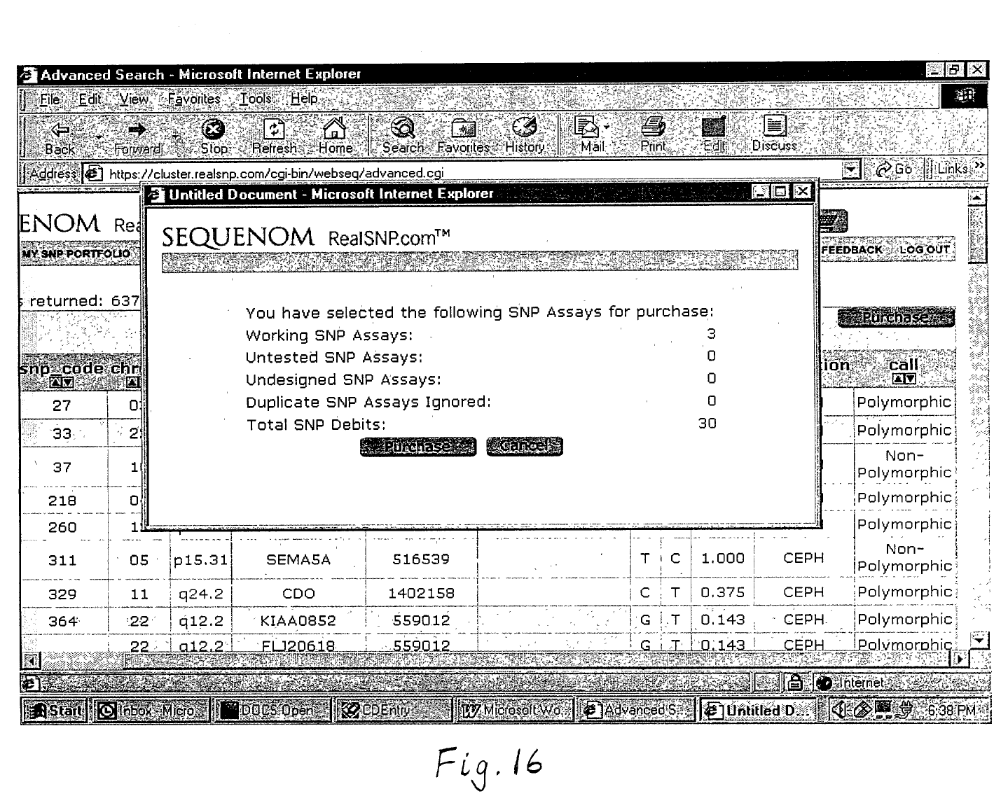

It is contemplated that the first genetic data format described above provides researchers with enough information to make a determination as to whether further information is desired. It is understood, however, that additional and/or different categories of information may be included in the first genetic data format as may be desired by the SNP database vendor. As described in further detail below with reference to FIGS. 16-20, a user may select one or more SNPs displayed in the first genetic data format of FIG. 12 to purchase further information (e.g., sequence and/or assay information) pertaining to the selected SNPs.

As mentioned above, in a preferred embodiment, the first data format includes a SNP Code which is a unique private code assigned to each respective SNP contained in the database. This SNP Code is provided as an internal reference code which is not related to publicly available SNP ID numbers assigned to SNPs in public databases and which are generally known and used by those of skill in the art. Thus, it is appreciated that the internal SNP Codes, used for internal identification purposes, do not allow users to associate the information provided in the first genetic data format with a generally known SNP ID number. Thus, if the user wants to obtain additional information about a particular SNP for free from a public database, he or she will not know which SNP stored in a public database necessarily corresponds to information provided in the first genetic data format of FIG. 12. In this way, if the user is interested in obtaining additional information about a particular SNP, he or she will be motivated to purchase that information from the SNP database vendor, rather than attempt to discover or obtain it from another source. However, as described above in connection with FIG. 6, this is not to say that a user who is interested in a single particular public SNP ID, known in advance of conducting a search, cannot obtain information about that SNP ID to be displayed in a first genetic data format. Additionally, when available, an Assay Code is assigned to respective SNPs to correlate assay information with each respective SNP. It is appreciated that these Assay Codes have no meaning outside of the SNP database system and, therefore, cannot be utilized to obtain assay information from an external source.

In one embodiment, the SNP Codes and Assay Codes are generated and assigned to each SNP and assay, respectively, based on a random number generator algorithm. Such types of algorithms are well-known in the art. In a preferred embodiment, SNPs are randomly sorted in a table format wherein each row contains information associated with a unique SNP, as discussed above with respect to FIGS. 2A and 2B. Thereafter, SNP Codes are sequentially assigned to each row in the table. Array Codes may be assigned to each row in a similar fashion.

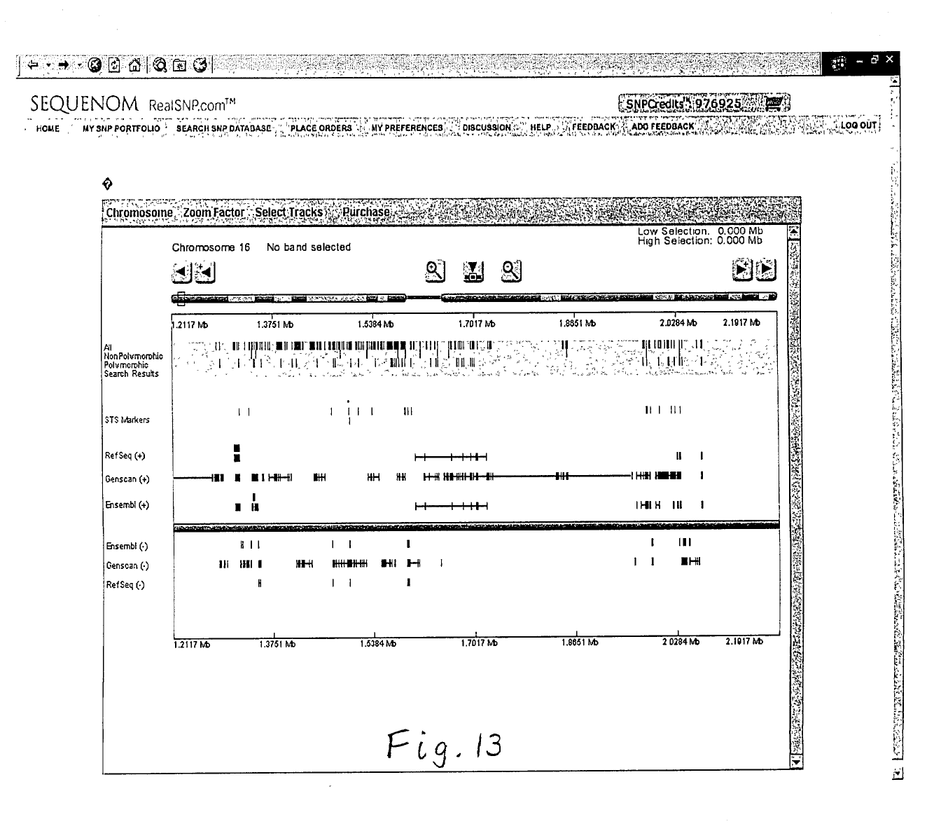

In a further embodiment, as illustrated in FIG. 13, the system can display a web page containing a graphical representation of SNP data associated with a particular chromosome (e.g., chromosome 16). The user may request this page by selecting a chromosome number or band (e.g., “p13.3”), for example, as shown in FIG. 12, using a graphics pointing device (e.g., mouse), for example. By clicking onto a particular chromosome number or band, a request is sent to the SNP database server to provide the desired web page. As shown in FIG. 13, the graphic representation page illustrates hash lines representing SNPs identified for particular regions of a chromosome. A first set of hash lines represents all SNPs (polymorphic and non-polymorphic) that have been observed and associated with the particular chromosome region. A second set of hash lines represents non-polymorphic SNPs associated with the particular chromosome region. A third set of hash lines represent polymorphic SNPs associated with the chromosome region. Finally, a fourth set of hash lines represent SNPs that are associated with the particular chromosome region and which meet other search criteria that may have been specified by the user.

FIG. 14 illustrates a single screen shot (i.e., portion) of an exemplary web page displaying search results, in a first genetic data format, for SNPs meeting search criteria including the gene keyword “cancer,” in accordance with one embodiment of the invention. The first genetic data format is essentially the same as the format illustrated in FIG. 12. Note, however, in FIG. 14 under the “chrom” column, various chromosome numbers are listed to indicate a respective chromosome associated with a respective SNP search result. Thus, it is apparent that the search results shown in FIG. 14 were not limited to SNPs associated with only a single chromosome. The invention allows users to search for SNP data based on any one of a variety of criteria, or any variety of combinations of multiple criteria.

In a preferred embodiment, the search results of FIGS. 12 and 14 may be sorted by the user according to various parameter (e.g., column) values. For example, utilizing well-known graphic user interface techniques and sorting algorithms, the search results may be sorted by ascending or descending chromosome numbers by clicking on appropriate up/down arrow keys provided for the “chrom” column as shown in FIGS. 12 and 14. Alternatively, the search results may be sorted by locus, assay code, allele data, population or polymorphic/non-polymorphic status, by clicking on appropriate arrow buttons associated with each respective column, as shown in FIGS. 12 and 14.

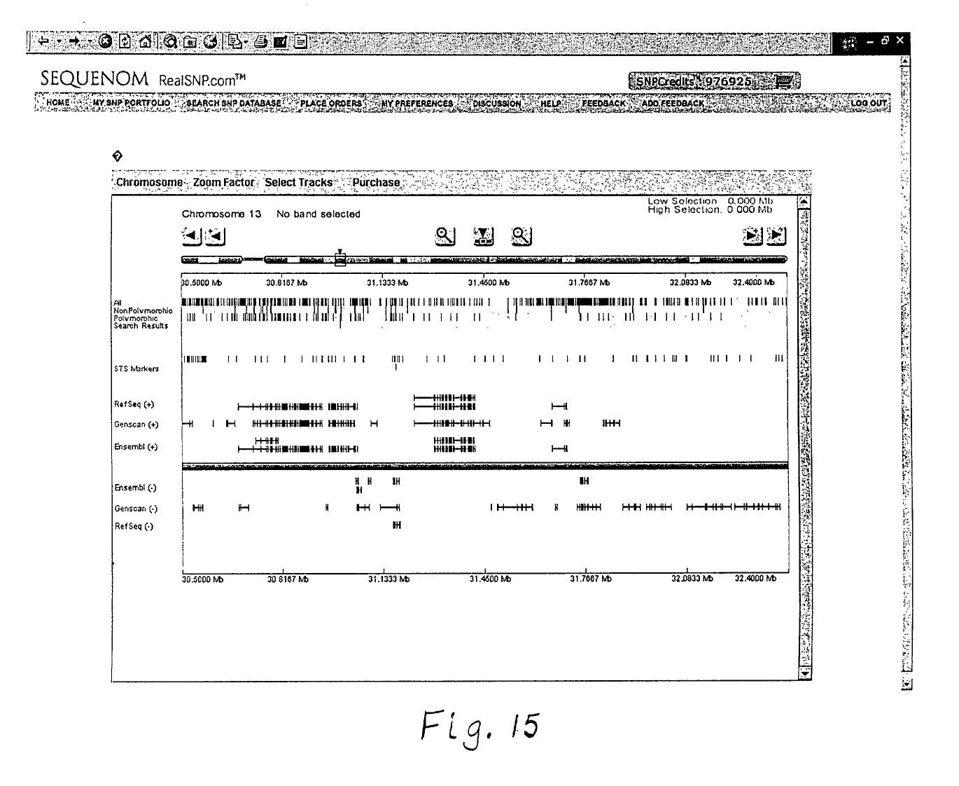

FIG. 15 illustrates an exemplary web page displaying a graphic representation of SNPs associated with chromosome 13 and further showing the first SNP search result listed in FIG. 14 (i.e., the SNP having a SNP Code of 4896) as a hash mark in the “Search Results” row of the graphic image. This graphic image was obtained by selecting the first SNP search result (note the check mark in the box adjacent to SNP Code 4896) and thereafter clicking on “q13.2” listed under the “band” column for that search result. As illustrated in FIGS. 13 and 15, in preferred embodiments, users can obtain a graphic representation of SNP data providing further visual information beyond that provided in the first genetic data formats illustrated by FIGS. 12 and 14. This visual representation provides an additional format for information, further assisting users to determine which SNPs, if any, they are interested in for the purpose of purchasing information.

Referring again to FIG. 12, after a user has reviewed the search results displayed in the first format, he or she can purchase further information for selected SNPs by clicking on respective “check boxes” adjacent the “SNP Code” for each desired SNP. As shown in FIG. 12, SNPs having SNP Codes 730, 74609 and 95626 have been selected. The user may then purchase additional information for these SNPs by clicking on a “Purchase” icon in the upper right corner of the web page.

FIG. 16 illustrates an exemplary pop-up window that is displayed to the user upon receiving a purchase order. The window provides messages that inform the user what additional information he or she has purchased. In a preferred embodiment, these messages indicate the number of “working SNP assays,” “untested SNP assays,” and “undesigned SNP assays” that have been ordered for purchase. In the example illustrated in FIG. 16, a first message indicates that three working SNP assays have been ordered. In a further embodiment, the pop-up window also indicates the number of “duplicate SNP assays ignored.” The number of “duplicate SNP assays ignored” reflects requests for purchasing assays which have previously been purchased by the researcher and stored in his or her “Personal SNPs” file or database, or assays which have previously been purchased by another researcher in the same company or organization as the present user and which have been stored in an “Organization SNPs” file or database. A further discussion of Personal and Organization SNPs databases is provided below in connection with FIGS. 17-20.

Upon receiving a purchase request, system software executed by the vendor server computer accesses the user's personal SNPs file and, if available, an organization SNPs file associated with the user, to determine whether any of the requested SNPs are already contained in these files. In a preferred embodiment, any duplicate requests are ignored and/or a message is sent to the user indicating that he or she has ordered a duplicate SNP. Thus, the system of the invention prevents the purchase of redundant information that is already available to a particular user.

As further shown in FIG. 16, the pop-up window provides a “total SNP debits” message that indicates an amount debited from the user's credit account, previously established with the vendor website. In the present example, a total of 30 debits have been deducted from the user's SNP credit account for the purchase of three working SNP assays. Therefore, the cost of each working assay is 10 debits. As is readily apparent, a debit unit can reflect any monetary unit, or fraction thereof, as may be desired and specified by the vendor. For example, each debit may correlate to one U.S. dollar, or any fraction thereof, and can be is used as a basis for tracking the volume of each client's purchases. Such types of online debit and credit systems are well known in the art. For example, the CharlesSchwab® company provides a web site at www.schwab.com that allows customers to apply for online investment services, establish a credit account, and, thereafter, conduct transactions which result in the debiting of their account in accordance with the type of transactions performed. Any known methods or systems of establishing online debit and credit accounts for conducting transactions over a computer network may be utilized in accordance with the present invention.

Referring again to any one of FIGS. 3-4, 6-8 or 12-15, the status of a user's credit account is displayed as a “SNPCredits” icon, with an associated balance amount, located at the upper right corner of these figures, above the tool bar. In a preferred embodiment, when a user transfers additional funds into his or her credit account, or makes purchases from the SNP database, the balance amount is automatically increased or decreased, respectively, to provide real-time updates concerning the user's account. In this way, clients of the present invention can easily monitor their purchasing capabilities and account for the purchases they have previously made.

After a user purchases SNP information from the SNP database, the purchased information is stored in a “Personal SNPs” file or database that contains only information purchased by that user. The user can always access this information at his or her leisure by clicking on a “My SNP Portfolio” icon in the tool bar as shown in FIG. 3, for example. After clicking on this icon, the user is presented with a web page displaying a summary of SNPs previously purchased by the user, as shown in FIG. 17. The user may then sort this information, as described above, per the user's preferences and, thereafter, view additional information for selected SNPs.

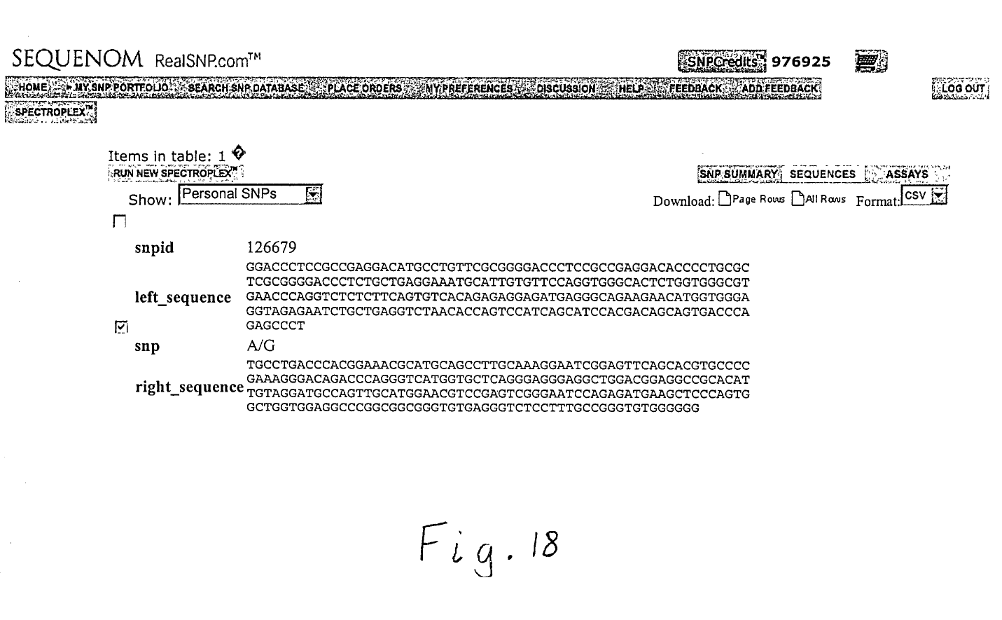

In one preferred embodiment, in order to view sequence information for a particular SNP, the user can click on a check box associated with a particular SNP and then click on a “Sequences” button or icon, as shown in the upper right corner of FIG. 17. Upon clicking on the “Sequences” button, a request is sent to the SNP database server to retrieve the sequence information for the selected SNP and, thereafter return a web page containing the desired information. FIG. 18 illustrates an exemplary web page displaying SNP sequence information that may be provided to the user. This web page identifies the SNP (e.g., alleles “A/G”), a nucleotide sequence to the left of the SNP and a nucleotide sequence to the right of the SNP.

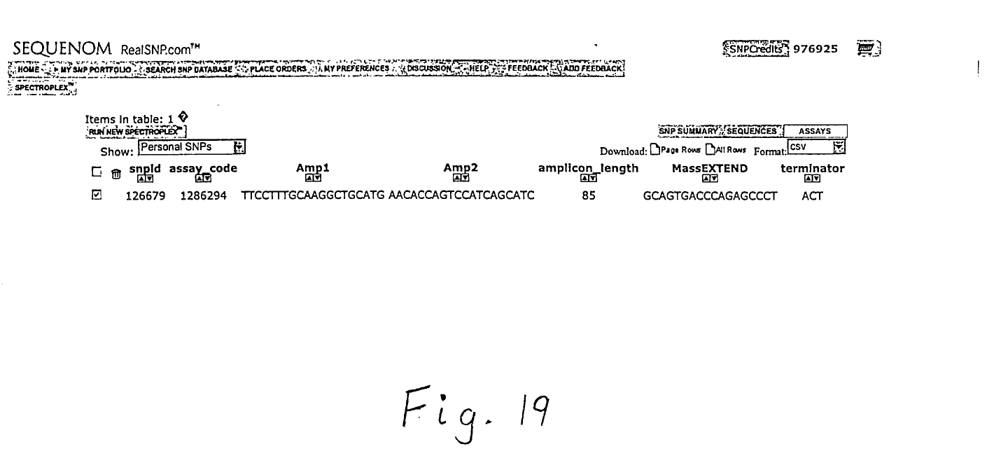

The user may also view assay information for the selected SNP by clicking on an “Assay” button or icon located adjacent to the “Sequences” button described above. Upon clicking on the “Assay” button, the user is presented with an exemplary web page as shown in FIG. 19. In a preferred embodiment, this Assay web page displays the selected SNP's publicly known “SNP ID,” an internal “Assay Code” that has been assigned to the SNP as described above, a first primer or oligonucleotide sequence (“Amp1”), a second oligonucleotide sequence (“Amp2”), an amplicon length, a “MassExtend™” Primer sequence, and a terminator sequence. Thus, the user is presented with necessary oligonucleotide primer sequence information to create a diagnostic assay for the selected SNP.

As used herein, the term “oligonucleotide” refers to a nucleic acid comprising about 8 to 50, or more, covalently linked nucleotides, often comprising from about 10 to about 25 nucleotides. The backbone and nucleotides within an oligonucleotide may be the same as those of naturally occurring nucleic acids, or analogs or derivatives of naturally occurring nucleic acids, provided that oligonucleotides containing such analogs or derivatives retain the ability to hybridize specifically to the nucleic acid comprising the targeted polymorphism. Such oligonucleotides may be synthesized using known methods and machines, such as the ABI™3900 High Throughput DNA Synthesizer and the EXPEDITE™ 8909 Nucleic Acid Synthesizer, both of which are available from Applied Biosystems (Foster City, Calif.), for example. Analogs and derivatives are exemplified in U.S. Pat. Nos. 4,469,863; 5,536,821; 5,541,306; 5,637,683; 5,637,684; 5,700,922; 5,717,083; 5,719,262; 5,739,308; 5,773,601; 5,886,165; 5,929,226; 5,977,296; 6,140,482; WO 00/56746; WO 01/14398, and related publications. Methods for synthesizing oligonucleotides comprising such analogs or derivatives are well known and disclosed, for example, in the patent publications cited above and in U.S. Pat. Nos. 5,614,622; 5,739,314; 5,955,599; 5,962,674; 6,117,992; in WO 00/75372, and in related publications.

As is also known in the art, oligonucleotides may also be linked to a second moiety. The second moiety may be an additional nucleotide sequence such as a tail sequence (e.g., a polyadenosine tail), an adaptor sequence (e.g., phage M13 universal tail sequence), and others. Alternatively, the second moiety may be a non-nucleotide moiety such as a moiety that facilitates linkage to a solid support or a label to facilitate detection of the oligonucleotide. Such labels include, without limitation, a radioactive label, a fluorescent label, a chemilluminescent label, a paramagnetic label, and the like. The second moiety may be attached to any position of the oligonucleotide, provided the oligonucleotide can hybridize to the nucleic acid comprising the polymorphism.

As discussed in the “Background” section above, numerous methods and techniques for designing oligonucleotide-based diagnostic assays are known in which the oligonucleotides typically hybridize to test nucleic acids at high stringency. In a preferred embodiment, such diagnostic assays are designed using the SpectroDesign™ software tool that is a publicly known and commercially available software tool developed by Sequenom, Inc. located in San Diego, Calif., U.S.A.

As shown in FIG. 19, in a preferred embodiment, the SNP database system stores and displays oligonucleotide primer pairs (Amp1, Amp2) suitable for use in a polymerase chain reaction (PCR), or in other nucleic acid amplification methods, for each SNP selected by the user, and for which an assay has been developed. Each oligonucleotide primer pair is typically complementary to a region surrounding the SNP. PCR primer pairs in the database may be used in any PCR method. For example, a PCR primer pair may be used in methods disclosed in U.S. Pat. Nos. 4,683,195; 4,683,202, 4,965,188; 5,656,493; 5,998,143; 6,140,054; WO 01/27327; and WO 01/27329 for example. PCR pairs may also be used in any commercially available machine that performs PCR reactions, such as any of the GENEAMP® Systems available from Applied Biosystems. Also, those of ordinary skill in the art will be able to design other suitable oligonucleotide primers without undue experimentation using knowledge readily available in the art in combination with the nucleotide sequences of the primers disclosed to the user, as illustrated in FIG. 19.

The third primer or oligonucleotide (“MassExtend™”) displayed to the user is useful for detecting SNPs in a nucleic acid. An extension oligonucleotide often hybridizes to a nucleic acid that comprises the polymorphism adjacent to the polymorphic site. Generally, the term “adjacent” with respect to extension oligonucleotides refers to the 3′ end of the extension oligonucleotide being often 1, and sometimes 2, 3, 4, 5, 6, 7, 8, 9, or 10 nucleotides from the 5′ end of the polymorphic site in the nucleic acid when the extension oligonucleotide is hybridized to the nucleic acid. A representative assay in which these oligonucleotides can be employed for identifying SNPs in a high-throughput fashion is a MassARRAY™ system which is commercially available from Sequenom, Inc. This genotyping platform is complemented by a homogeneous, single-tube assay method (hME™ or homogeneous MassEXTEND™ method) in which the two oligonucleotide primers anneal to and amplify a genomic target surrounding a polymorphic site of interest. The third oligonucleotide (the MassEXTEND™ primer), which is complementary to the amplified target up to but not including the polymorphism, is then enzymatically extended a few bases through the polymorphic site and then terminated with a termination sequence (e.g., “ACT”).

Various methods and techniques for designing and performing assays, using the information illustrated in FIG. 19, would be readily apparent to those of ordinary skill in the art. For example, in one embodiment, the initial PCR amplification reaction is performed in a 5 μl total volume containing 1× PCR buffer with 1.5 mM MgCl₂ (Qiagen), 50 μM each of dATP, dGTP, dCTP, dTTP (Gibco-BRL), 2.5 ng of genomic DNA, 0.1 units of HotStar DNA polymerase (Qiagen), and 200 nM each of forward and reverse PCR primers specific for the polymorphic region of interest. Samples are incubated at 95° C. for 15 minutes, followed by 45 cycles of 95° C. for 20 seconds, 56° C. for 30 seconds, and 72° C. for 1 minutes, finishing with a 3 minute final extension at 72° C. Following amplification, shrimp alkaline phosphatase (SAP) (0.3 units in a 2 μl volume) (Amersham Pharmacia) is added to each reaction (total reaction volume was 7 μl) to remove any residual dNTPs that was not consumed in the PCR step. Samples are incubated for 20 minutes at 37° C., followed by 5 minutes at 85° C. to denature the SAP.

Once the SAP reaction is complete, a primer extension reaction is initiated by adding a polymorphism-specific MassEXTEND™ primer cocktail to each sample. Each MassEXTEND™ cocktail includes a specific combination of ddNTPs and dNTPs used to distinguish polymorphic alleles from one another. The MassEXTEND™ reaction is performed in a total volume of 9 μl with the addition of 1× ThermoSequenase buffer, 0.576 units of ThermoSequenase (Amersham Pharmacia), 600 nM MassEXTEND™ primer, 2 mM of ddATP and/or ddCTP and/or ddGTP and/or ddTTP, and 2 mM of DATP or dCTP or dGTP or dTTP. The dideoxy (dd) nucleotide used in the assay is complementary to the nucleotide at the polymorphic site in the amplicon. Samples are incubated at 94° C. for 2 minutes, followed by 45 cycles of 5 seconds at 94° C., 5 seconds at 52° C., and 5 seconds at 72° C.

Following incubation, samples are desalted by adding 16 μl of water (total reaction volume was 25 μl), 3 mg of sample cleaning beads (e.g., SpectroCLEAN™ from Sequenom, Inc.) and allowed to incubate for 3 minutes with rotation. Samples are then robotically dispensed using a piezoelectric dispensing device (e.g., SpectroJET™ from Sequenom, Inc.) onto either 96-spot or 384-spot silicon chips containing a matrix that crystallized each sample (e.g., SpectroCHIP™ from Sequenom, Inc.). Subsequently, MALDI-TOF mass spectrometry using Biflex and Auto flex MALDI-TOF mass spectrometers, for example, can be used and SpectroTYPER RT™ software from Sequenom, Inc., for example, are used to analyze and interpret the SNP genotype for each sample.

In one embodiment, after the oligonucleotide sequences are displayed to the user as shown in FIG. 19, the user may place an order directly with a vendor for delivery of the physical oligonucleotides having the same nucleotide sequences as those displayed by selecting or clicking on a “Place Orders” button or icon as shown in the toolbar of the web page of FIG. 19. Upon clicking on this button, a purchase request is sent to the vendor server that will then handle the request in accordance with an established protocol. In one embodiment, the vendor itself is the supplier of the requested primers and delivers the requested products to the user and, thereafter, debits the user's credit account for an appropriate amount. In other embodiments, the vendor may submit the purchase request to one or more third part suppliers who will then submit bids or price quotes for the purchase order.

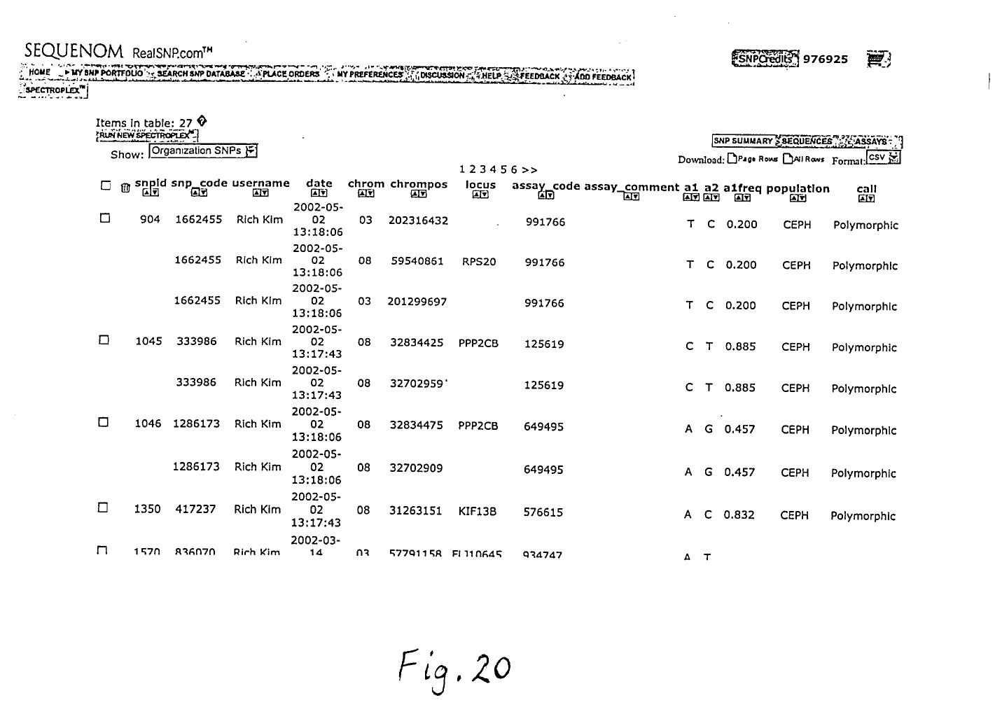

Referring to FIG. 20, in one preferred embodiment, when multiple individuals from a single company or organization are granted access to the SNP database, an “Organization SNPs” database, or file, is created and an organization credit account is established for that organization. The organization registers each individual with the SNP database vendor and each individual (referred to herein as an “organization researcher”) is assigned a login and passcode to access the SNP database. When an organization researcher purchases SNP data, that data is stored in a personal SNPs file for that individual researcher as well as an “Organization SNPs” file containing data purchased by all organization researchers registered by a particular organization. FIG. 20 illustrates a screen shot of an exemplary web page that shows all of the SNPs previously purchased by researchers associated with one organization. In a preferred embodiment, a user who is registered with the SNP vendor as belonging to the organization can access this page by selecting “Organization SNPs” from a pull down menu, as shown in the upper left corner of FIG. 20.

In this way, the invention allows multiple researchers belonging to an organization, company, or other collaborative group, to share information that has previously been purchased. Additionally, in a preferred embodiment, when an organization researcher requests to purchase data associated with a particular SNP, software executed by the vendor server computer will search the “Organization SNPs” database to determine if the requested data has previously been purchased. If the requested data is already contained in the Organization SNPs database, a message is sent to the organization researcher that his or her “duplicate” purchase request has been ignored. If the requested data is not contained in the Organization SNPs database, a purchase transaction is executed by delivering and storing the requested information to the researcher's Personal SNPs database as well as to the Organization SNPs database, and an appropriate debit amount is deducted from the organizations credit account.

Various preferred embodiments of the invention have been described above. However, it is understood that these various embodiments are exemplary only and should not limit the scope of the invention. Various modifications to the preferred embodiments would be readily apparent to and easily implemented by those of ordinary skill in the art, without undue experimentation. Different types of information may be stored in the relational database and related in various ways. Different types of messages and information may be displayed to the user and different types of search criteria may be made available to the user of the present invention. For example, searches may also optionally be facilitated by indexing genetic polymorphisms with certain disorders. Certain genetic polymorphisms have been associated with disorders such as cell proliferative disorders, cell differentiation disorders, and disorders involving the brain, heart, metabolism, and pain, for example. Many of these disorders are known and/or documented in the literature. Further, searches may be optionally facilitated by indexing genetic polymorphsims with the frequency that a polymorphic allele occurs in a population. The user typically selects a frequency threshold value, for example, by searching the database for an allele corresponding to a genetic polymorphism that occurs in less than or more than a certain fraction of a population. The user may select any frequency for a particular allele as a threshold. Thus, genetic polymorphisms may be indexed by the frequency with which an allele corresponding to the polymorphism is represented in a population, provided frequency information is available. These are just a few examples illustrating the various capabilities of the present invention and modifications that may be made to the preferred embodiments discussed above. These various modifications and equivalents are contemplated to be within the spirit and scope of the invention as set forth in the claims below.

What is claimed is:

1. A computer-based method of providing genetic data, comprising:
receiving at least one search criterion from a user;
searching a database for genetic data meeting said at least one search criterion;
displaying at least a portion of said genetic data in a first genetic data format, wherein said first genetic data format comprises at least one data entry meeting said at least one search criterion;
receiving a purchase request for additional information associated with said at least one data entry;
retrieving said additional information from said database;
storing said additional information in a memory location associated with said user such that said additional information may be subsequently accessed and viewed by said user; and
automatically debiting a credit account associated with said user by a predetermined amount.

2. The method of claim 1 wherein said genetic data comprises SNP information and said first genetic data format comprises chromosome and gene locus information for at least one SNP meeting said at least one search criterion.

3. The method of claim 1 wherein said genetic data comprises SNP information and said first genetic data format comprises allele frequency and population information for at least one SNP meeting said at least one search criterion.

4. The method of claim 1 wherein said genetic data comprises SNP information and said first genetic data format comprises validated/non-validated status information for at least one SNP meeting said at least one search criterion.

5. The method of claim 1 wherein said genetic data comprises SNP information and said additional information comprises sequence information pertaining to at least one SNP.

6. The method of claim 1 wherein said genetic data comprises SNP information and said additional information comprises assay information pertaining to at least one SNP.

7. The method of claim 1 wherein said memory location comprises a personal file stored in said database, wherein said, personal file stores information previously purchased by said user, and said method further comprises:
checking whether said additional information has previously been stored in said personal file; and
if said additional information has previously been stored in said personal file, ignoring said purchase, request, so as to not debit said credit account, and notifying said user of a duplicate purchase request.

8. The method of claim 1 wherein said memory location comprises an organization file stored in said database, wherein said organization file stores information previously purchased by said user and other designated persons associated with said user, and said method further comprises:
checking whether said additional information has previously been stored in said organization file; and
if said additional information has previously been stored in said organization file, ignoring said purchase request, so as to not debit said credit account, and notifying said user of a duplicate purchase request.

9. A computer-based method of providing SNP data, comprising:
receiving at least one SNP search criterion from a user;
searching a database for SNP data meeting said at least one SNP search criterion;
displaying at least a portion of said SNP data in a first genetic data format, wherein said first genetic data format comprises at least one SNP data entry meeting said at least one search criterion and further comprises, for each SNP data entry, chromosome, gene locus, allele frequency, population and validated/non-validated status information;
receiving a purchase request for additional information associated with at least one of said SNP data entries;
retrieving said additional information from said database;
storing said additional information in a memory location associated with said user such that said additional information may be subsequently accessed and viewed by said user; and
automatically debiting a credit account associated with said user by a predetermined amount.

10. The method of claim 9 wherein said additional information comprises sequence information pertaining to said at least one SNP data entry.

11. The method of claim 9 wherein said additional information comprises assay information pertaining to said at least one SNP data entry.

12. The method of claim 9 wherein said memory location comprises a ersonal SNPs file stored in said database, wherein said personal SNPs file stores information previously purchased by said user, and said method further comprises:
checking whether said additional information has previously been stored in said personal SNPs file; and
if said additional information has previously been stored in said personal SNPs file, ignoring said purchase request, so as to not debit said credit account, and notifying said user of a duplicate purchase request.

13. The method of claim 9 wherein said memory location comprises an organization SNPs file stored in said database, wherein said organization SNPs file stores information previously purchased by said user and other designated persons associated with said user, and said method further comprises:
checking whether said additional information has previously been stored in said organization SNPs file; and
if said additional information has previously been stored in said organization SNPs file, ignoring said purchase request, so as to not debit said credit account, and notifying said user of a duplicate purchase request.

14. A computer-based system of providing genetic data, comprising:
means for receiving at least one search criterion from a user;
means for searching a database for genetic data meeting said at least one search criterion;
means for displaying at least a portion of said genetic data in a first genetic data format, wherein said first genetic data format comprises at least one data entry meeting said at least one search criterion;
means for receiving a purchase request for additional information associated with said at least one data entry;
means for retrieving said additional information from said database;
means for storing said additional information in a memory location associated with said user such that said additional information may be subsequently accessed and viewed by said user; and
means for automatically debiting a credit account associated with said user by a predetermined amount.

15. The system of claim 14 wherein said genetic data comprises SNP information and said first genetic data format comprises chromosome and gene locus information for at least one SNP meeting said at least one search criterion.

16. The system of claim 14 wherein said genetic data comprises SNP information and said first genetic data format comprises allele frequency and population information for at least one SNP meeting said at least one search criterion.

17. The system of claim 14 wherein said genetic data comprises SNP information and said first genetic data format comprises validated/non-validated status information for at least one SNP meeting said at least one search criterion.

18. The system of claim 14 wherein said genetic data comprises SNP information and said additional information comprises sequence information pertaining to at least one SNP.

19. The system of claim 14 wherein said genetic data comprises SNP information and said additional information comprises assay information pertaining to at least one SNP.

20. The system of claim 14 wherein said memory location comprises a personal file stored in said database, wherein said personal file stores information previously purchased by said user, and said system further comprises:
means for checking whether said additional information has previously been stored in said personal file; and
means for notifying said user of a duplicate purchase request if said additional information has previously been stored in said personal file.

21. The system of claim 14 wherein said memory location comprises an organization file stored in said database, wherein said organization file stores information previously purchased by said user and other designated persons associated with said user, and said system further comprises:
means for checking whether said additional information has previously been stored in said organization file; and
means for notifying said user of a duplicate purchase request if said additional information has previously been stored in said organization file.
